(19) United States
(12) Patent Application Publication
(10) Pub. No.: US 2026/0249462 A1
(43) Pub. Date: Aug. 27, 2026

(54) ROBOT CONTROL METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Shuai WANG, Shenzhen (CN)

(73) Assignee: TENCENT TECHNOLOGY (SHENZHEN) COMPANY LIMITED, Shenzhen (CN)

(21) Appl. No.: 19/649,450

(22) Filed: Apr. 16, 2026

Related U.S. Application Data
(63) Continuation of application No. PCT/CN2025/079516, filed on Feb. 27, 2025.

(30) Foreign Application Priority Data
Mar. 4, 2024 (CN) 202410247226.5

(51) Int. Cl. B25J 9/16

(52) U.S. Cl. CPC B25J 9/1666; B25J 9/1607; B25J 9/163; B25J 9/1676

(57) ABSTRACT

A method and apparatus, and a computer-readable medium for an improved robot control process is provided. The method obtains a current state parameter of a to-be-controlled robot at a current moment. A basic control parameter of each joint of the to-be-controlled robot is determined based on a preset dynamics model and the current state parameter. Parameter filtering on the basic control parameter is performed to obtain a safety control parameter of each joint of the to-be-controlled robot. A motion control parameter of each joint of the to-be-controlled robot is determined based on the safety control parameter of each joint. Each joint of the to-be-controlled robot at the current moment is controlled based on the motion control parameter of each joint.

### CROSS REFERENCE TO RELATED APPLICATION

This application is a bypass continuation application of International Patent Application No. PCT/CN2025/079516, filed on Feb. 27, 2025, which claims priority to and is based on Chinese Patent Application No. 202410247226.5, filed on Mar. 4, 2024, the disclosures of which are incorporated herein in their entireties by reference.

### FIELD

This application relates to the artificial intelligence field, and in particular, to a robot control method and apparatus, an electronic device, a computer-readable storage medium, and a computer program product.

### BACKGROUND

With development of industrial automation and artificial intelligence technologies, robot control technologies are widely applied to the fields of manufacturing, medical treatment, farming, transportation, and the like, bringing great convenience and benefits to people's production and life. The robot control technologies are various control means for enabling a robot to complete various tasks and motion. The robot control technologies usually include the following control technologies: an energy-based passive control theory, adaptive dynamic planning, adaptive optimization and output regulation, and the like.

In the related art, the robot control technologies focus more on effect of robot control and less on robustness of robot control, to be specific, balanced control effect for a robot under impact of strong external disturbance. The robustness of robot control determines operation stability of the robot in an unknown environment and fault tolerance of an abnormal case during actual application, and is of great significance to safety control of the robot.

### SUMMARY

Provided are a robot control method and apparatus, and a computer-readable storage medium, to implement safety control on a robot and improve robustness of robot control.

According to an aspect of some embodiments of the present disclosure, a robot control method, performed by an electronic device, includes: obtaining a current state parameter of a to-be-controlled robot at a current moment; determining a basic control parameter of each joint of the to-be-controlled robot based on a preset dynamics model and the current state parameter; performing parameter filtering on the basic control parameter to obtain a safety control parameter of each joint of the to-be-controlled robot; determining a motion control parameter of each joint of the to-be-controlled robot based on the safety control parameter of each joint; and controlling each joint of the to-be-controlled robot at the current moment based on the motion control parameter of each joint.

According to an aspect of some embodiments of the present disclosure, a robot control apparatus, including: at least one memory configured to store program code; and at least one processor configured to read the program code and operate as instructed by the program code, the program code including: an obtaining code configured to cause the at least one of the at least one processor to obtain a current state parameter of a to-be-controlled robot at a current moment; a basic control parameter determining code configured to cause the at least one of the at least one processor to invoke a state regulator to determine a basic control parameter of each joint of the to-be-controlled robot based on a preset dynamics model and the current state parameter; a parameter filtering code configured to cause the at least one of the at least one processor to perform parameter filtering on the basic control parameter to obtain a safety control parameter of each joint of the to-be-controlled robot; a motion control parameter determining code configured to cause the at least one of the at least one processor to determine a motion control parameter of each joint of the to-be-controlled robot based on the safety control parameter of each joint; and a control code configured to cause the at least one of the at least one processor to control each joint of the to-be-controlled robot at the current moment based on the motion control parameter of each joint.

According to an aspect of some embodiments of the present disclosure, a non-transitory computer-readable storage medium, storing computer code, the computer code which, when executed by at least one processor, causes the at least one processor to at least: obtain a current state parameter of a to-be-controlled robot at a current moment; determine a basic control parameter of each joint of the to-be-controlled robot based on a preset dynamics model and the current state parameter; perform parameter filtering on the basic control parameter to obtain a safety control parameter of each joint of the to-be-controlled robot; determine a motion control parameter of each joint of the to-be-controlled robot based on the safety control parameter of each joint; and control each joint of the to-be-controlled robot at the current moment based on the motion control parameter of each joint.

The above general descriptions and the following detailed descriptions are merely for exemplary and explanatory purposes, and cannot limit the present disclosure. Details of one or more embodiments of the present disclosure are set forth in the accompanying drawings and descriptions below. Other features and advantages of the present disclosure will be apparent from the specification, accompanying drawings, and claims.

### BRIEF DESCRIPTION OF THE DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a structural diagram of an architecture of a robot control system according to an embodiment of the present disclosure.

FIG. 2 is a structural diagram of a robot control apparatus according to an embodiment of the present disclosure.

FIG. 3 is an exemplary schematic flowchart of a robot control method according to an embodiment of the present disclosure.

FIG. 4 is another exemplary schematic flowchart of a robot control method according to an embodiment of the present disclosure.

FIG. 5 is a structural diagram of a robot according to an embodiment of the present disclosure.

FIG. 6 is a whole-body side view of a robot on a vertical plane according to an embodiment of the present disclosure.

FIG. 7 is a diagram of rotation around a lateral sway rotation center of a robot according to an embodiment of the present disclosure.

FIG. 8 is a diagram of a two-wheel motion mode of a robot according to an embodiment of the present disclosure.

FIG. 9 is a diagram of an obstacle crossing mode of a robot according to an embodiment of the present disclosure.

FIG. 10 is a block diagram of a robot control system according to an embodiment of the present disclosure.

FIG. 11 is a structural diagram of a second-order wheel inverted pendulum according to an embodiment of the present disclosure.

FIG. 12 is a schematic flowchart of a robot control method according to an embodiment of the present disclosure.

FIG. 13 is a diagram of an inverted pendulum model of a robot according to an embodiment of the present disclosure.

FIG. 14a is a diagram 1 of simulation effect of robot control according to an embodiment of the present disclosure.

FIG. 14b is a diagram 2 of simulation effect of robot control according to an embodiment of the present disclosure.

FIG. 14c is a diagram 3 of simulation effect of robot control according to an embodiment of the present disclosure.

FIG. 14d is a diagram 4 of simulation effect of robot control according to an embodiment of the present disclosure.

FIG. 14e is a diagram 5 of simulation effect of robot control according to an embodiment of the present disclosure.

FIG. 14f is a diagram 6 of simulation effect of robot control according to an embodiment of the present disclosure.

FIG. 15 is a diagram of simulation of a rotation angle of a wheel-hub motor of a left wheel according to an embodiment of the present disclosure.

FIG. 16 is a diagram of simulation of a rotation angle of a wheel-hub motor of a left wheel when a lower limit of a safety constraint is changed to −π according to an embodiment of the present disclosure.

### DETAILED DESCRIPTION

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following descriptions, the term “some embodiments” describes subsets of all possible embodiments, but “some embodiments” may be the same subset or different subsets of all the possible embodiments, and may be combined with each other without conflict.

If similar descriptions of “first/second” appear in the present disclosure, the following descriptions are added: In the following descriptions, the terms “first”, “second”, and “third” are merely intended to distinguish between similar objects rather than describe a specific order of objects. The “first”, “second”, and “third” are interchangeable in order in proper circumstances, so that the embodiments of the present disclosure described herein can be implemented in an order other than the order illustrated or described herein.

In the embodiments of the present disclosure, the term “module” or “unit” is a computer program having a predetermined function or a part of a computer program, operates together with other related parts to achieve a predetermined objective, and may be all or partially implemented by software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, all technical and scientific terms used in the embodiments of the present disclosure have the same meanings as those commonly understood by a person skilled in the art to which the present disclosure belongs. Terms used in the embodiments of the present disclosure are merely intended to describe the embodiments of the present disclosure, but not to limit the present disclosure.

During related data collection and processing in the embodiments of the present disclosure in an exemplary application, informed consent or individual consent of a personal information subject needs to be obtained in strict accordance with requirements of related laws and regulations, and subsequent data use and processing are performed within an authorized scope of laws and regulations and the personal information subject.

Robot technologies relate to design, manufacturing, operation, and use of a robot. An objective of the robot technologies is to design a machine that can help and assist human beings. The robot technologies integrate the fields of mechanical engineering, electrical engineering, information engineering, mechatronics, electronics, biological engineering, computer engineering, control engineering, software engineering, mathematics, and the like, and are to gain further development in the future. The solutions provided in the embodiments of the present disclosure relate to artificial intelligence-based robot technologies, and are described by using the following embodiments: In the robot technologies, to achieve a balance between wheels of a robot, a proportional-integral-derivative (PID) controller is used, or a model-based controller such as a linear quadratic regulator (LQR) or a model predictive control (MPC) controller is used. These controllers are based on a wheel inverted pendulum model, and achieve a balance between wheels of a robot by using an energy-based passive control theory, adaptive dynamic planning, adaptive optimization and output regulation, or the like.

In the related art, although a robust control method similar to the foregoing is proposed for a second-order wheel inverted pendulum system, a simplified model of a robot is not promoted to any higher order, leading to a specific limitation. In addition, the second-order wheel inverted pendulum system in the related art is applied only to the simplified model of the robot, is not combined with whole-body dynamics control (WBC), and has no global control policy or effect on robot control. Moreover, the related art includes only an application scenario of two-wheel balancing, and does not include application scenarios of four-wheel traveling, expected switching between a four-wheel state and a two-wheel state, and the like.

The foregoing method focuses more on effect of robot control and less on robustness of robot control. In a robot control system, the robustness is a capability of keeping performance unchanged and accurately completing a predetermined task when the system faces various interferences, disturbances of uncertainty, model errors, external disturbances, and internal parameter changes. In short, the robustness represents a capability of the robot control system to keep operating reliably in a complex and changing environment.

Based on at least one of the foregoing technical problems existing in the related art, in the embodiments of the present disclosure, a safety controller is introduced based on a simplified model of a second-order wheel inverted pendulum, and a reference center of mass (COM) trajectory applicable to a WBC architecture may be obtained based on a state observer. Then a constraint inequality obtained through theoretical derivation by the safety controller is established, and the constraint inequality is substituted into a whole-body dynamics controller, to combine WBC and safety control, to implement safety control on a robot and improve robustness of robot control.

The following describes exemplary application of a robot control device (namely, an electronic device) provided in the embodiments of the present disclosure. The electronic device provided in the embodiments of the present disclosure may be implemented as various types of terminals such as a robot, a notebook computer, a tablet computer, a desktop computer, a set-top box, a smartphone, a smart speaker, a smartwatch, a smart television, and an in-vehicle terminal, or may be implemented as a server. The following describes an exemplary application in a case that the robot control device is implemented as a server.

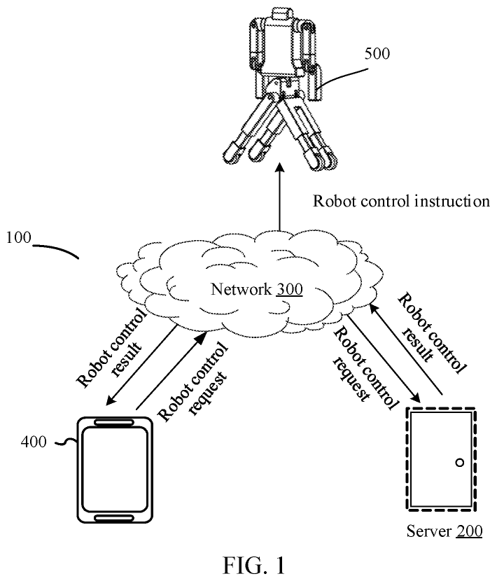

FIG. 1 is a structural diagram of a robot control system 100 according to an embodiment of the present disclosure. To support a robot control application, a terminal 400 runs the robot control application. The terminal 400 is connected to a server 200 through a network 300. The network 300 may be a wide area network, a local area network, or a combination thereof.

The terminal 400 is configured to transmit a robot control request to the server 200. The server 200 constitutes the robot control device in the embodiments of the present disclosure. The server 200 is configured to: obtain a current state parameter of a to-be-controlled robot 500 at a current moment when the robot control request is transmitted; then determine a basic control parameter of each joint of the to-be-controlled robot 500 based on a preset dynamics model and the current state parameter; then perform parameter filtering on the basic control parameter to obtain a safety control parameter of each joint of the to-be-controlled robot 500; then determine a motion control parameter of each joint of the to-be-controlled robot 500 based on the safety control parameter of each joint; and finally control each joint of the to-be-controlled robot 500 at the current moment based on the motion control parameter of each joint, to obtain a robot control result at the current moment. When controlling the to-be-controlled robot 500, the server 200 may generate a robot control instruction, the robot control instruction carrying the motion control parameter of each joint; and the server 200 may transmit the robot control instruction to the to-be-controlled robot 500, to control the to-be-controlled robot 500.

In some embodiments, after obtaining the robot control result at the current moment, the server 200 may return the robot control result at the current moment to the terminal 400, so that the terminal 400 outputs the robot control result or the terminal 400 performs robot control at a next moment based on the robot control result. For example, a motion trajectory of the to-be-controlled robot when the robot control instruction is displayed on the terminal 400 as the robot control result.

In some embodiments, the server 200 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal and the server may be directly or indirectly connected through wired or wireless communication. This is not limited in the embodiments of the present disclosure.

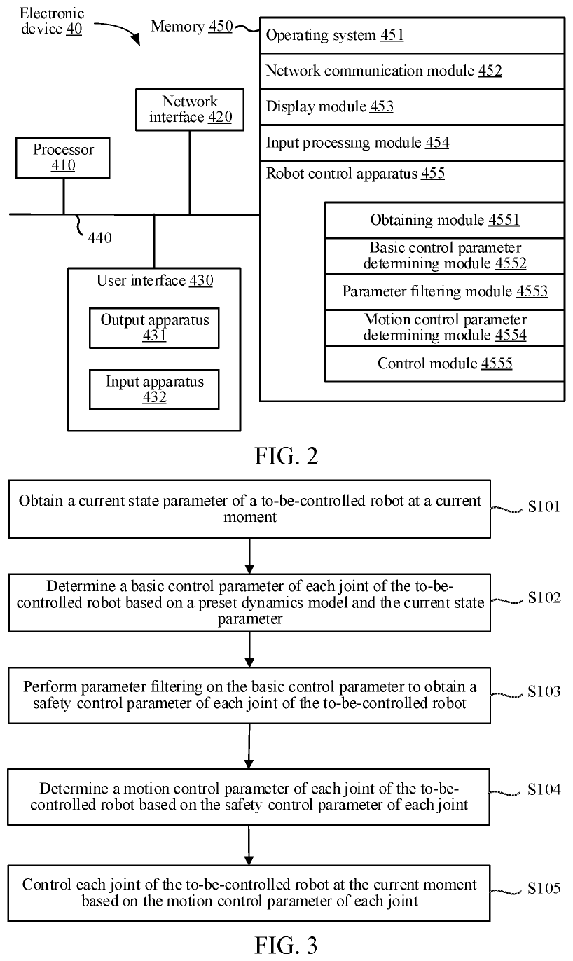

FIG. 2 is a structural diagram of an electronic device 40 according to an embodiment of the present disclosure. The electronic device 40 shown in FIG. 2 may be a robot control device. The robot control device includes at least one processor 410, a memory 450, at least one network interface 420, and a user interface 430. The components in the robot control device are coupled together through a bus system 440. The bus system 440 is configured to implement connection and communication between the components. In addition to a data bus, the bus system 440 further includes a power bus, a control bus, and a state signal bus. However, for clarity of description, all types of buses in FIG. 2 are marked as the bus system 440.

The processor 410 may be an integrated circuit chip with a signal processing capability, for example, a general-purpose processor, a digital signal processor (DSP), another programmable logic device, a discrete gate or transistor logic device, or a discrete hardware component. The general-purpose processor may be a microprocessor, any conventional processor, or the like.

The user interface 430 includes one or more output apparatuses 431 capable of displaying media content, including one or more speakers and one or more visual displays. The user interface 430 further includes one or more input apparatuses 432, including user interface components for facilitating user inputs, for example, a keyboard, a mouse, a microphone, a touch display, a camera, or other input buttons or controls.

The memory 450 may be a removable memory, a non-removable memory, or a combination thereof. For example, a hardware device includes a solid-state memory, a hard disk drive, or an optical drive. In some embodiments, the memory 450 includes one or more storage devices physically located away from the processor 410. The memory 450 includes a volatile memory or a nonvolatile memory, or may include both a volatile memory and a nonvolatile memory. The nonvolatile memory may be a read-only memory (ROM). The volatile memory may be a random access memory (RAM). The memory 450 described in this embodiment of the present disclosure is intended to include any suitable type of memory. In some embodiments, the memory 450 can store data to support various operations. Examples of the data include a program, a module, and a data structure or a subset or superset thereof. Examples are described below:

An operating system 451 includes system programs for processing various basic system services and performing hardware-related tasks, for example, a framework layer, a core library layer, and a driver layer, for implementing various basic services and processing hardware-based tasks. A network communication module 452 is configured to reach another electronic device through one or more (wired or wireless) network interfaces 420, exemplary network interfaces 420 including Bluetooth, wireless fidelity (Wi-Fi), universal serial bus (USB), and the like. A display module 453 is configured to display information by using one or more output apparatuses 431 (for example, a display or a speaker) associated with the user interface 430 (for example, a user interface for operating a peripheral device and displaying content and information). An input processing module 454 is configured to detect one or more user inputs or interactions from one or more input apparatuses 432 and translate the detected inputs or interactions.

In some embodiments, the apparatus provided in the embodiments of the present disclosure may be implemented by using software. FIG. 2 shows a robot control apparatus 455 stored in the memory 450. The robot control apparatus may be software in a form of a program or plug-in, and includes the following software modules: an obtaining module 4551, a basic control parameter determining module 4552, a parameter filtering module 4553, a motion control parameter determining module 4554, and a control module 4555. These modules are logical modules, and therefore may be flexibly combined or further split based on implemented functions. Functions of the modules are described below.

In some other embodiments, the robot control apparatus provided in embodiments of the present disclosure may be implemented by using hardware. In an example, the apparatus provided in embodiments of the present disclosure may be a processor in a form of a hardware decoding processor, and is programmed to perform the robot control method provided in the embodiments of the present disclosure. For example, the processor in the form of the hardware decoding processor may be one or more application-specific integrated circuits (ASICs), DSPs, programmable logic devices (PLDs), complex programmable logic devices (CPLDs), field programmable gate arrays (FPGAs), or other electronic elements.

In some embodiments, the terminal or the server may run various computer-executable instructions or computer programs to implement the robot control method provided in the embodiments of the present disclosure. For example, the computer-executable instruction may be a microprogram-level command, a machine instruction, or a software instruction. The computer program may be a native program or a software module in an operating system; or may be a native application (APP), to be specific, a program that needs to be installed in an operating system for running; or may be a mini program that can be embedded into any APP, to be specific, a program that only needs to be downloaded to a browser environment for running. To sum up, the computer-executable instruction may be an instruction in any form, and the computer program may be an application, a module, or a plug-in in any form.

The robot control method provided in the embodiments of the present disclosure may be performed by an electronic device. The electronic device may be a server or a terminal. To be specific, the robot control method in the embodiments of the present disclosure may be performed by the server, or may be performed by the terminal, or may be performed through interaction between the server and the terminal. Alternatively, the robot control method may be performed by a robot. When the robot control method is performed by a robot, the robot is a to-be-controlled robot. Motion control on the robot is implemented by controlling each joint of the robot. In this case, the robot constitutes the electronic device in the embodiments of the present disclosure.

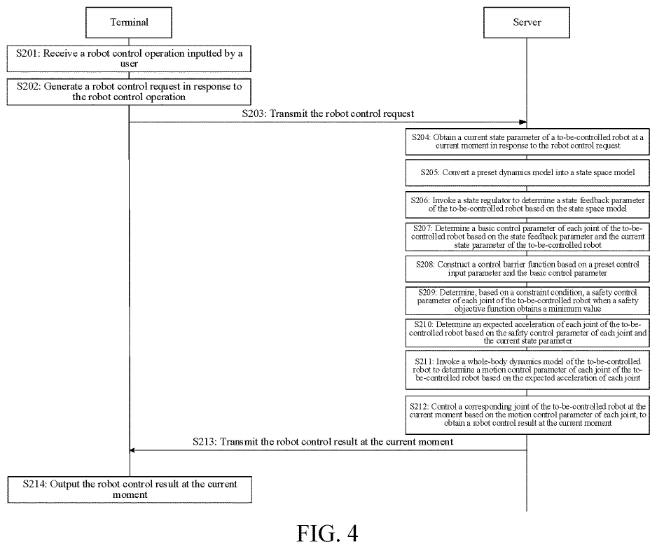

FIG. 3 is an exemplary schematic flowchart of a robot control method according to an embodiment of the present disclosure. The robot control method is described based on operations shown in FIG. 3 by using an example in which the robot control method is performed by a server. The method includes the following operation S101 to operation S105.

Operation S101: Obtain a current state parameter of a to-be-controlled robot at a current moment.

In this embodiment of the present disclosure, the to-be-controlled robot is a robot that needs to complete an expected task through safety control. Depending on different structures, the to-be-controlled robot may include at least the following types: a stationary robot, a mobile robot, a multi-joint robot, and the like. The stationary robot is a robot installed at a fixed position, and is a robot for repetitive tasks, for example, a six-axis robotic arm or a welding robot. The mobile robot is a robot that can autonomously move in an environment, and is highly flexible, for example, an automated guided vehicle (AGV) or a vacuum cleaning robot. The multi-joint robot is a robot that has a plurality of joints and can perform complex motion, for example, a surgical robot or a humanoid robot. The to-be-controlled robot in this embodiment of the present disclosure includes a mobility wheel, a head, a torso, a waist, and a leg. Every two parts are connected and controlled by different joints.

A joint of the to-be-controlled robot is a core component in robot kinematics and dynamics, and is configured to connect different links to implement motion and operations of the robot. Design and control of the joint directly affect flexibility, precision, and a motion range of the robot. The joint is a mechanical part for connecting two or more links in the robot, and allows relative motion between the links. The joint may be revolute or prismatic, depending on a motion mode of the joint. Based on motion modes, joints may be classified into the following main types: a revolute joint, a prismatic joint, a spherical joint, and a universal joint. The revolute joint allows rotational motion between links around a fixed axis. The prismatic joint allows linear motion between links along a fixed direction, and is applied to a robot requiring linear motion, for example, a telescopic arm or a lifting platform. The spherical joint allows multi-degree-of-freedom rotational motion between links around a point, and is applied to a robot requiring high flexibility, for example, a wrist and an ankle of a humanoid robot. The universal joint allows rotational motion between links around two perpendicular axes, and is applied to a robot requiring high flexibility, for example, a joint of a robotic arm.

Kinematics and dynamics of joints are important concepts in robotics, and are configured to describe and control motion of a robot. The kinematics of joints includes forward kinematics and inverse kinematics. The forward kinematics is to calculate a position and a pose of an end effector of a robot based on a joint angle. The inverse kinematics is to calculate a joint angle based on a target position and a pose of an end effector. Dynamics technologies of joints include a dynamics model and a dynamics control policy. The dynamics model is configured to describe a force-torque relationship during movement of a robot, including an inertia force, gravity, friction, and the like. The dynamics control policy is to implement stable movement of a robot by controlling torques and velocities of joints.

Joint control is an important part of a robot control system, and includes at least the following several control policies: position control, velocity control, and force control. The position control is to implement precise movement by controlling an angle or a position of the joint. The velocity control is to implement smooth movement by controlling a velocity of the joint. The force control is to implement interaction with an environment by controlling a torque or a force of the joint.

The current state parameter is a series of state parameters of each joint during movement of the to-be-controlled robot at the current moment, for example, a position, a velocity, or an acceleration of the robot, a joint angle, a joint velocity, sensor data, a rotation angle of the mobility wheel, a rotational angular velocity, a rotational angular acceleration, a joint torque, and a joint angular velocity.

When the current state parameter of the to-be-controlled robot at the current moment is obtained, a type of a state parameter that needs to be obtained may be first determined, and then a state parameter of each type is obtained in sequence. A method for obtaining the state parameter depends on a hardware configuration of the robot and a sensor type. For example, for the position and the velocity among the state parameters, a position of the to-be-controlled robot may be obtained by using a position sensor (for example, an encoder, a laser rangefinder, or a visual sensor), and a velocity of the to-be-controlled robot is obtained by using a velocity sensor (for example, a gyroscope or a speedometer). For the force and the torque among the state parameters, a force between the to-be-controlled robot and an environment may be obtained by using a force sensor, and a joint torque is measured by using a torque sensor. Certainly, the visual sensor, for example, a camera, may alternatively be used to perform visual feedback to obtain a position and a pose of the robot, and a depth sensor is used to obtain three-dimensional information of the environment.

In some embodiments, data processing and fusion need to be performed on the obtained state parameters, to improve accuracy and reliability of data. The obtained state parameters may be processed in data processing manners such as data filtering and data synchronization. The data filtering includes low-pass filtering (to remove high-frequency noise) and Kalman filtering (to fuse data of a plurality of sensors to improve estimation precision). For example, accuracy of pose estimation of the robot may be improved by combining data of an inertial measurement unit (IMU) and the visual sensor. The data synchronization may include timestamp synchronization to ensure that data of different sensors is aligned in time, and data interpolation to fill a data sampling interval. For example, sensor data may be synchronized based on the network time protocol (NTP).

Operation S102: Determine a basic control parameter of each joint of the to-be-controlled robot based on a preset dynamics model and the current state parameter.

In this embodiment of the present disclosure, the preset dynamics model is a robot dynamics model obtained by modeling robot dynamics by using a robot dynamics modeling method. The robot dynamics model is a mathematical model for describing a motion-force relationship of the to-be-controlled robot. The robot dynamics model covers all joints, links, and dynamics characteristics of the to-be-controlled robot. The robot dynamics model is configured to predict and control motion of the robot, including the position, the velocity, the acceleration, and the like, and is a key part of robot control, motion planning, and simulation. The robot dynamics describes a relationship between a joint torque, a dynamics parameter, and joint motion. The robot dynamics modeling method may include at least one of the following: a Newton-Euler method, a Lagrange method, a Kane method, an operator algebra method, and the like.

In the robot dynamics model, the joint torque is a key part of the dynamics model, and the joint torque describes a torque needed by each joint. An inertia matrix is a symmetric positive definite matrix, and describes an inertial characteristic of the to-be-controlled robot. The inertia matrix depends on a joint angle. A Coriolis force and centrifugal force matrix describes impact of a joint velocity on the joint torque. A gravity vector describes impact of gravity on the joint torque, and the gravity vector also depends on the joint angle. An external torque describes impact of an external force on the joint torque.

In some embodiments, the basic control parameter includes a joint torque of each joint and a torque of a rotating wheel. The basic control parameter of each joint may be determined by designing a feedback controller by using a state regulator, for example, an LQR. A specific implementation process is: converting the preset dynamics model into a spatial state model; converting the robot control system from an open-loop system to a closed-loop system by configuring a feedback matrix, so that the closed-loop system reaches an expected system state; and finally calculating the basic control parameter of each joint of the to-be-controlled robot based on a relationship between the feedback matrix and the basic control parameter.

In some other embodiments, the basic control parameter may further include a target position, a velocity, an acceleration, and the like. These parameters may be determined through the following operations: First, set a target position and velocity according to a task requirement. For example, if the task is to move the end effector of the to-be-controlled robot to a position, the target position may be coordinates of the position, and the target velocity may be zero. Then calculate an expected acceleration. The expected acceleration may be calculated through inverse dynamics. An objective of the inverse dynamics is to calculate an acceleration needed by each joint based on the target position and velocity, and the acceleration may be calculated by using a PID controller or another control policy. Then perform calculation on a control input to obtain the basic control parameter. The control input (for example, the joint torque) may be calculated by using the PID controller.

After the basic control parameter is obtained, the basic control parameter may be directly transmitted to a motor of the to-be-controlled robot, to control the robot. However, during robot control, due to lack of whole-body coordination, subsequent parameter processing further needs to be performed on the basic control parameter to implement safety control on the to-be-controlled robot.

Operation S103: Perform parameter filtering on the basic control parameter to obtain a safety control parameter of each joint of the to-be-controlled robot.

The parameter filtering is a process of performing parameter optimization on the basic control parameter, and the safety control parameter obtained through parameter filtering is an optimized control parameter. An objective of the parameter filtering is to reduce noise and interference in the basic control parameter, to improve stability and safety of a robot system. A control signal can be smoothed through parameter filtering, to avoid control instability caused by a rapid change or an abnormal value. The parameter filtering process may be completed by designing a safety controller, for example, a controller based on a control barrier function (CBF). The safety controller is a method for controlling safety of the robot system, and may limit a state of the robot system by defining a CBF. When the state of the robot system approaches an unsafe area, the safety controller automatically adjusts a control policy, to ensure safety of the robot system. The basic control parameter may be considered as an original control policy of the robot system before the safety controller is applied, and the safety control parameter of each joint of the to-be-controlled robot may be considered as a control policy of the safety controller obtained through solving.

In this embodiment of the present disclosure, an optimized control policy for the robot system can be obtained through parameter filtering on the basic control parameter, to improve control stability of the robot system and ensure safety of the robot system.

Operation S104: Determine a motion control parameter of each joint of the to-be-controlled robot based on the safety control parameter of each joint.

In this embodiment of the present disclosure, the motion control parameter of each joint is a to-be-solved variable obtained by solving a whole-body dynamics model by using a quadratic programming (QP) optimizer, and the motion control parameter may be an optimized joint torque, contact force, joint acceleration, or the like. Herein, the QP optimizer is a tool or an algorithm for solving a QP problem. The QP is a special optimization problem. An objective function of the QP is quadratic, and a constraint condition may be linear. During robot control, the QP optimizer is configured to optimize the control input, to enable the to-be-controlled robot to achieve an optimal performance indicator while meeting a dynamics constraint and a kinematics constraint. In this embodiment of the present disclosure, the whole-body dynamics model of the to-be-controlled robot may be invoked to implement whole-body control on the to-be-controlled robot. The whole-body control is priority-based multitasking control. The safety control parameter of each joint is used as an input for a current task to obtain an expected operation space task parameter for movement of the to-be-controlled robot. Then the expected operation space task parameter is substituted into the whole-body dynamics model of the to-be-controlled robot for solving, to obtain the motion control parameter of each joint of the to-be-controlled robot.

Herein, the whole-body dynamics model of the to-be-controlled robot is combined with a safety control theory to obtain a motion control parameter, optimized according to the safety control theory, of each joint, to subsequently implement safety control on the to-be-controlled robot by using the motion control parameter.

Operation S105: Control each joint of the to-be-controlled robot at the current moment based on the motion control parameter of each joint.

In this embodiment of the present disclosure, after the motion control parameter of each joint is obtained, the motion control parameter of each joint may be converted into a target control instruction for a corresponding joint, and the target control instruction is transmitted to a control motor that controls the joint. The control motor controls the corresponding joint of the to-be-controlled robot at the current moment, to obtain a robot control result at the current moment. For example, when the motion control parameter is a joint angle, a joint angular velocity, and a joint torque of a knee joint of the robot, the target control instruction may be a target joint angle control instruction, a target joint angular velocity control instruction, and a target joint torque control instruction for the knee joint of the robot. The target control instruction is transmitted to a knee joint control motor, and the knee joint control motor drives the knee joint of the to-be-controlled robot to move.

In this embodiment of the present disclosure, the calculated motion control parameter is applied to an effector (namely, a control motor) of each joint, and the control motor drives the joint to move, to enable the to-be-controlled robot to reach an expected state. During control, a state of the to-be-controlled robot may be further detected in real time, and a control policy is adjusted based on feedback information, to ensure accuracy and stability of control.

According to the robot control method provided in this embodiment of the present disclosure, after the current state parameter of the to-be-controlled robot at the current moment is obtained, the basic control parameter of each joint of the to-be-controlled robot is determined based on the preset dynamics model and the current state parameter, and parameter filtering is performed on the basic control parameter to obtain the safety control parameter of each joint of the to-be-controlled robot. In this way, through parameter filtering on the basic control parameter of each joint of the to-be-controlled robot, parameter filtering can be performed on an original control parameter of the to-be-controlled robot, to convert a control parameter obtained through filtering into a control parameter applicable to the robot safety control theory. In this way, the control parameter is a control parameter optimized relative to the original control parameter of the robot. Therefore, precise safety control can be performed on the to-be-controlled robot based on the optimized control parameter. In addition, in this embodiment of the present disclosure, the whole-body dynamics model of the to-be-controlled robot is invoked to determine the motion control parameter of each joint of the to-be-controlled robot based on the safety control parameter of each joint, and then a corresponding joint of the to-be-controlled robot is controlled at the current moment based on the motion control parameter of each joint. In this way, the motion control parameter of each joint is calculated based on the whole-body dynamics model by using the safety control parameter of each joint of the to-be-controlled robot as an input for the whole-body dynamics model, and then safety control is implemented on the joint of the to-be-controlled robot based on the motion control parameter of each joint. In this way, the to-be-controlled robot is controlled as a whole based on the motion control parameter of each joint of the to-be-controlled robot, to improve robustness of robot control.

The following describes the robot control method in the embodiments of the present disclosure based on interaction between a terminal and a server in a robot control system. The robot control method herein is a robot control method implemented through interaction between the terminal and the server, and is substantially the same as the robot control method performed by the server in the foregoing embodiments. A difference lies only in that actions performed by the terminal during execution of the robot control method are further described in this embodiment of the present disclosure, and some operations may be performed by the terminal or the server. Therefore, for operations in this embodiment that have the same content as those in the foregoing embodiments but are performed by a different entity, this embodiment is merely an example for description. During implementation, the operations may be performed by any entity. This is not limited in this embodiment of the present disclosure.

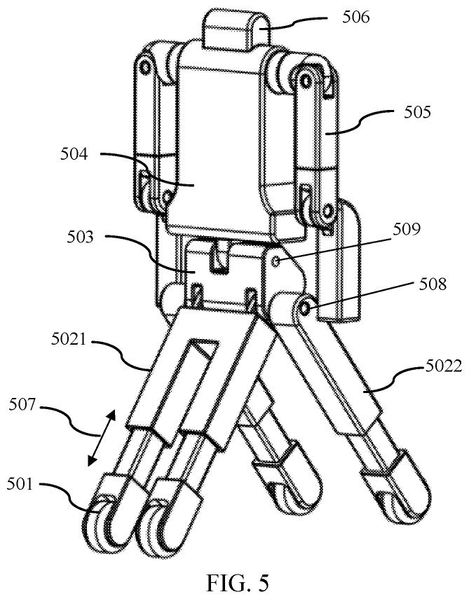

FIG. 4 is another exemplary schematic flowchart of a robot control method according to an embodiment of the present disclosure. As shown in FIG. 4, the method includes the following operation S201 to operation S214.

Operation S201: A terminal receives a robot control operation inputted by a user.

In this embodiment of the present disclosure, the user may input the robot control operation to a client of a robot control application. The robot control application may provide a robot control function. The user (who may be a robot control designer or a robot user) may input the robot control operation to a robot control function page, to trigger a robot control request.

In some embodiments, when inputting the robot control operation, the user may further input a current state parameter of a to-be-controlled robot at a current moment. When receiving the current state parameter of the to-be-controlled robot at the current moment, the terminal displays a robot control confirmation window on the robot control function page. After detecting that the user clicks/taps a robot control confirmation button, the terminal performs further parameter processing on the current state parameter of the to-be-controlled robot at the current moment, to determine a motion control parameter of the to-be-controlled robot. Alternatively, in some other embodiments, the user may directly input the current state parameter of the to-be-controlled robot at the current moment on the robot control function page, and when receiving the current state parameter of the to-be-controlled robot at the current moment, the terminal may directly trigger the robot control function, to perform further parameter processing on the current state parameter of the to-be-controlled robot at the current moment and determine a motion control parameter of the to-be-controlled robot, to implement safety control on the to-be-controlled robot.

In an application scenario, the terminal may be implemented as a robot. To be specific, the user may perform a control operation through the robot. The control operation inputted by the user may be a click/tap operation, a parameter input operation, a voice control operation, or the like. The voice control operation is used herein as an example for description. The user may wake up the robot through a voice control instruction, and transmit an instruction “Get me an apple from the kitchen” to the robot through the voice control instruction. In this case, when receiving the voice control instruction of the user, the robot determines that the current state parameter at the current moment includes: a target position [kitchen]; a target object [apple]; and time [now].

Operation S202: The terminal generates a robot control request when receiving the robot control operation.

In this embodiment of the present disclosure, data inputted by the user may be encapsulated into the robot control request. For example, the current state parameter of the to-be-controlled robot at the current moment is displayed on a display interface of the robot control application, the user may perform parameter selection or parameter sampling according to an actual requirement, and then the current state parameter, inputted by the user, of the to-be-controlled robot at the current moment is encapsulated into the robot control request.

Operation S203: The terminal transmits the robot control request to a server.

In some embodiments, the terminal transmits the encapsulated robot control request to the server, and requests the server to control the to-be-controlled robot. The terminal may transmit the robot control request based on a protocol like HTTP or WebSocket. When the terminal is a robot, the terminal may request to control the robot. When the terminal is another electronic device different from the robot, the robot control request may further carry an identifier of the to-be-controlled robot, to indicate a control target to the server.

Operation S204: The server obtains the current state parameter of the to-be-controlled robot at the current moment when receiving the robot control request.

In some embodiments, if the current state parameter at the current moment is encapsulated into the robot control request, the current state parameter may be directly obtained through parsing when receiving the robot control request.

Herein, after receiving the robot control request, the server parses the robot control request. For example, for an HTTP request, the server may parse a request header and a request body: parse the request header to obtain related information of the request; and parse the request body to obtain main data of the request, to be specific, the current state parameter of the to-be-controlled robot at the current moment. A specific field or parameter in the request body is parsed. The field or the parameter includes the current state parameter of the to-be-controlled robot at the current moment. A specific data format, for example, JSON or XML, is extracted from the request body, and then the data format is parsed to obtain the current state parameter of the to-be-controlled robot at the current moment.

Operation S205: The server converts a preset dynamics model into a state space model.

In this embodiment of the present disclosure, the state space model is a mathematical model for describing dynamic behavior of a robot system. A state variable describes dynamic characteristics of the robot system. The state space model reveals an internal relationship of the robot system. An input variable causes a change in the state variable, and the change in the state variable determines a change in an output variable. The state space model mainly includes a state equation and an output equation. The state equation describes a rule of the state variable of the robot system varying with time. The output equation describes a relationship between the output variable of the robot system, the state variable, and the input variable. During control on the to-be-controlled robot, the state space model is configured for describing dynamics behavior of the to-be-controlled robot. A controller may be designed by using the state equation and the output equation, to implement precise motion control on the to-be-controlled robot. For example, a PID controller, an LQR controller, or an MPC controller may be designed by using the state space model.

The operation of converting the preset dynamics model into the state space model is mainly intended to simplify an equation system of the preset dynamics model into a form of \dot{x}=Ax+Bu, where x represents the state variable, i represents a derivative of the state variable, A and B are simplified system matrices, and u is a control parameter of the to-be-solved state space model. The preset dynamics model is converted into the state space model, so that an input parameter of the state space model, to be specific, a basic control parameter of each joint of the to-be-controlled robot, can be subsequently obtained through solving by using the state space model.

Operation S206: The server invokes a state regulator to determine a state feedback parameter of the to-be-controlled robot based on the state space model.

In this embodiment of the present disclosure, an objective of the state regulator is to find a group of control parameters, to reduce changes in the control parameters and make the state variable sufficiently small, so that the robot system reaches a stable state. The state regulator may be an LQR. The state regulator may be invoked to design a feedback controller to convert the state space model from an open-loop system to a closed-loop system. The feedback controller includes a state feedback parameter. The state feedback parameter of the to-be-controlled robot may be obtained by calculating a minimum value of a quadratic objective function of the feedback controller.

Herein, the closed-loop system is controlled by using the state feedback parameter, so that the robot system can achieve better control performance, and the robot system can reach a stable state.

Operation S207: The server determines the basic control parameter of each joint of the to-be-controlled robot based on the state feedback parameter and the current state parameter of the to-be-controlled robot.

In this embodiment of the present disclosure, when the state feedback parameter of the to-be-controlled robot is obtained, the state feedback parameter may be multiplied by the state variable in the current state parameter to obtain the basic control parameter of each joint of the to-be-controlled robot. To be specific, for each joint of the to-be-controlled robot, a state variable of the joint in the current state parameter may be obtained, and then a product of the state feedback parameter and the state variable of the joint is determined as a basic control parameter of the joint.

The state variable in the current state parameter may include at least one of the following: a position variable, a velocity variable, an acceleration variable, a force and torque variable, and other state variables. The position variable may be a joint position (for example, a rotation angle or a translational distance of each joint) and an end effector position (to be specific, position coordinates of an end effector of the to-be-controlled robot in space). The velocity variable may be a joint velocity (to be specific, a rotational velocity or a translational velocity of each joint) and an end effector velocity (to be specific, a linear velocity and an angular velocity of the end effector of the to-be-controlled robot in space). The acceleration variable may be a joint acceleration (to be specific, a rotational acceleration or a translational acceleration of each joint) and an end effector acceleration (to be specific, a linear acceleration and an angular acceleration of the end effector of the to-be-controlled robot in space). The force and torque variable may be a joint torque (to be specific, a torque applied to each joint) and an end effector force (to be specific, a force applied to the end effector of the to-be-controlled robot). The other state variables may include a battery level (to be specific, a battery level of the to-be-controlled robot) and a temperature (for example, a motor temperature and a joint temperature). These state variables constitute state space of the to-be-controlled robot, and are the basis of robot control and motion planning. Precise control and state monitoring on the to-be-controlled robot can be implemented by obtaining these state variables in real time.

Operation S208: The server constructs a CBF based on a preset control input parameter and the basic control parameter.

In this embodiment of the present disclosure, the preset control input parameter is a decision variable predefined according to an actual control requirement. A designer may select an appropriate value for the decision variable to best achieve a control objective of the robot system. The decision variable may be configured to describe system characteristics of the robot system. The CBF includes a safety objective function and a constraint condition. The CBF controls an action of the to-be-controlled robot by introducing the safety objective function into a dynamic control process of the robot system and optimizing a specified constraint condition, to achieve a specific control objective. A constraint condition applicable to the robot system is designed based on the safety objective function and the control objective of the robot system. The safety objective function includes the preset control input parameter and the basic control parameter. For example, the safety objective function may be defined as a variable value that enables a squared modulus value of a difference between the preset control input parameter and the basic control parameter to reach a minimum value.

Herein, the CBF may be considered as a safety controller. The CBF is constructed, so that an optimized safety control policy of the safety controller, namely, a safety control parameter of each joint, can be subsequently obtained based on the safety objective function and the constraint condition in the CBF, and safety control is implemented on the to-be-controlled robot based on the safety control parameter.

Operation S209: The server determines, based on the constraint condition, the safety control parameter of each joint of the to-be-controlled robot when the safety objective function obtains a minimum value.

In this embodiment of the present disclosure, the safety control parameter of each joint is a variable value that enables the safety objective function to obtain the minimum value under a limitation of the constraint condition. A specific implementation process of determining the safety control parameter is: first, substituting the preset control input parameter and the basic control parameter of each joint into the safety objective function to calculate a squared modulus value, to obtain a plurality of squared modulus values of each joint, the calculating a squared modulus value being to perform a modulus value squaring operation on a complex number; and then selecting a smallest squared modulus value of each joint, determining a basic control parameter corresponding to the smallest squared modulus value, and determining the basic control parameter as a safety control parameter of a corresponding joint.

Operation S210: The server determines an expected acceleration of each joint of the to-be-controlled robot based on the safety control parameter of each joint and the current state parameter.

In this embodiment of the present disclosure, the expected acceleration includes an expected acceleration of a supporting wheel of the to-be-controlled robot, an expected acceleration of a torso in a vertical direction, an expected attitude angular acceleration of the torso, an expected acceleration of a swinging wheel, and an expected COM acceleration. The safety control parameter of each joint and the current state parameter are used as input parameters of a state observer. The state observer performs calculation on the safety control parameter of each joint and the current state parameter, and outputs the expected acceleration of each joint of the to-be-controlled robot.

In some embodiments, a whole-body dynamics model of the to-be-controlled robot includes a state controller. The state observer is a tool for estimating a system state, and is especially applicable to a case that not all of state variables can be directly measured. The state observer is configured to reconstruct an internal state of the robot system based on an input and an output of the robot system. A main function of the state observer is to provide a real-time estimated value of a system state of the robot, to help the robot better understand and adjust system behavior. The state observer may be used for feedback control, to improve stability and performance of the robot system. In short, the state observer deduces, based on known inputs and outputs, state variables that cannot be directly measured. A basic principle of the state observer is based on a mathematical model of the robot system. In the robot system, the state observer may be configured to estimate a state of the robot, for example, a position, a velocity, an acceleration, and a pose.

In a robot control task, the state observer may estimate a state parameter of the robot based on sensor data (for example, a joint angle and IMU data). For example, in the robot control task, the state observer may estimate, based on the joint angle and the IMU data, a difference between a projection of a CoM of the robot on the ground and a projection of a wheel center on the ground, to determine the expected acceleration of each joint of the to-be-controlled robot based on the difference.

In some embodiments, the state observer may be implemented by designing an observer gain based on the mathematical model of the robot system. An implementation method for the state observer includes a full-order state observer and a reduced-order state observer. The full-order state observer is configured to estimate all state variables, and is applicable to a case that a system state is completely observable. The reduced-order state observer is configured to estimate a part of state variables, and is applicable to a case that a system state is partially observable.

In some embodiments, the current state parameter includes an actual state variable, and the expected acceleration includes an expected COM acceleration. The expected COM acceleration may be determined in the following manner: invoking the state observer to determine the following parameters based on the safety control parameter of each joint and the current state parameter: a reference COM position and a reference COM velocity of the to-be-controlled robot, a reference distance between the reference COM position and a current virtual contact point, and a reference velocity corresponding to the reference distance; then determining a reference state variable based on the reference distance, the reference velocity, the reference COM position, and the reference COM velocity; then invoking a state regulator to determine a state feedback parameter of a pre-constructed inverted pendulum model; and finally determining an expected COM acceleration of each joint based on the state feedback parameter of the pre-constructed inverted pendulum model, the reference state variable, and the actual state variable.

To be specific, it is assumed that mass of the to-be-controlled robot is concentrated at the COM and a center of a connection line between two supporting wheels is a current virtual contact point between an inverted pendulum and the ground, and the COM is connected to the current virtual contact point to construct an inverted pendulum model of the to-be-controlled robot. The state observer is invoked to obtain, through programming by using a heuristic or model-based method, a reference COM position and a reference COM velocity of the CoM of the to-be-controlled robot along a heading direction, a reference distance between the reference COM position and the current virtual contact point, and a reference velocity corresponding to the reference distance. The reference COM position, the reference COM velocity, the reference distance between the reference COM position and the current virtual contact point, and the reference velocity corresponding to the reference distance are combined to form a reference state variable of the pre-constructed inverted pendulum model. Then the state feedback parameter of the pre-constructed inverted pendulum model is calculated by using an LQR. Parameters in the actual state variable and parameters in the reference state variable are in a one-to-one correspondence, and the actual state variable is included in the pre-obtained current state parameter. A difference between the reference state variable and the actual state variable is obtained, and then the difference is multiplied by the state feedback parameter to obtain the expected COM acceleration of each joint.

Herein, the expected COM acceleration of each joint is determined, to not only determine a reference trajectory of the CoM of the to-be-controlled robot, but also keep a dynamic balance of the robot.

Operation S211: The server invokes the whole-body dynamics model of the to-be-controlled robot to determine a motion control parameter of each joint of the to-be-controlled robot based on the expected acceleration of each joint.

The whole-body dynamics model of the robot is a mathematical model for describing a motion-force relationship of the robot, and covers all joints, links, and dynamics characteristics of the robot. The whole-body dynamics model is mainly configured to predict and control motion of the robot, including a position, a velocity, an acceleration, and the like. The whole-body dynamics model plays an important role in path planning, motion control, and dynamics simulation of the robot. The whole-body dynamics model is used for motion planning and control of the robot. The whole-body dynamics model optimizes a motion trajectory based on dynamics characteristics of the robot, to ensure stability and accuracy of the robot in a complex task. For example, during planning and control of a bipedal robot, the whole-body dynamics model is configured to generate a motion trajectory for walking on a flat ground, climbing stairs, resuming a balance, or the like.

In some embodiments, the whole-body dynamics model may generate the motion trajectory by using a numerical solver based on a Lagrange equation or a Newton-Euler equation in combination with geometrical and dynamics parameters of the robot. That is, the whole-body dynamics model may obtain the motion control parameter of each joint of the to-be-controlled robot by solving a dynamics equation. For example, in a humanoid robot, the whole-body dynamics model may generate a motion trajectory by using an ALIGATOR solver.

The whole-body dynamics model in this embodiment of the present disclosure includes the state observer for estimating the system state and the dynamics equation. The system state is estimated by using the state observer, to obtain the expected acceleration of each joint of the to-be-controlled robot. Then the motion control parameter of each joint of the to-be-controlled robot is predicted by using the dynamics equation of the whole-body dynamics model, to control motion of the robot.

In this embodiment of the present disclosure, the invoking the whole-body dynamics model of the to-be-controlled robot to determine a motion control parameter of each joint of the to-be-controlled robot based on the expected acceleration of each joint may be implemented in the following manner: first, invoking the whole-body dynamics model of the to-be-controlled robot and the state regulator to construct a corresponding objective function based on the expected acceleration of each joint; then obtaining a preset parameter constraint condition for each joint of the to-be-controlled robot, and determining a minimum value of the objective function of each joint based on the parameter constraint condition; and finally determining the motion control parameter of each joint of the to-be-controlled robot based on the minimum value.

To be specific, a relational expression between the expected acceleration of each joint, a joint spatial velocity, and a joint spatial acceleration is combined with the whole-body dynamics model of the to-be-controlled robot to obtain a to-be-solved dynamics equation of the to-be-controlled robot, and the expected acceleration of each joint is substituted into the to-be-solved dynamics equation to obtain a to-be-solved variable of the to-be-solved dynamics equation, to be specific, the motion control parameter of each joint of the to-be-controlled robot. Herein, combining the relational expression between the expected acceleration of each joint, the joint spatial velocity, and the joint spatial acceleration with the whole-body dynamics model of the to-be-controlled robot means combining a plurality of equations or relational expressions to form a complete equation system and then simultaneously solving the equations. During robot control, a control input for each joint may be obtained by combining the whole-body dynamics model, a relationship between a joint spatial velocity and an acceleration, and a relationship between an expected acceleration and an actual acceleration, to implement precise control on the robot. During solving, a constraint condition may be further added to the to-be-solved variable based on a body structure of the to-be-controlled robot and a physical limitation of a motor. In addition, during solving of the dynamics equation, a QP optimizer (for example, an LQR) may be further used to construct an objective function, and then an appropriate QP optimizer is selected based on the foregoing constraint condition to obtain a minimum value of the objective function. In this way, the motion control parameter of each joint of the to-be-controlled robot can be obtained through solving.

Operation S212: The server controls a corresponding joint of the to-be-controlled robot at the current moment based on the motion control parameter of each joint, to obtain a robot control result at the current moment.

In some embodiments, the controlling a corresponding joint of the to-be-controlled robot at the current moment may be further implemented in the following manner: first, constructing a safety constraint condition for the to-be-controlled robot; then invoking the whole-body dynamics model of the to-be-controlled robot to determine a first motion control parameter of each joint of the to-be-controlled robot based on the safety control parameter of each joint and the safety constraint condition; and finally, for each joint of the to-be-controlled robot, controlling a corresponding joint of the to-be-controlled robot at the current moment based on a first motion control parameter of the joint.

Herein, there are a plurality of safety constraint conditions. To further ensure safety control on the to-be-controlled robot, a plurality of CBFs are additionally designed. During solving of the first motion control parameter of each joint, a plurality of safety constraint conditions are additionally added based on the plurality of CBFs, so that the first motion control parameter, obtained through solving, of each joint is more applicable to the control objective of the robot system, to implement effective safety control on the to-be-controlled robot.

The safety control parameter of each joint includes a safe rotation angle and a safe rotational angular velocity, and constructing a plurality of safety constraint conditions for the to-be-controlled robot may be implemented in the following manner: first, determining a safety control parameter range of the safe rotation angle and a safety control parameter range of the safe rotational angular velocity; then constructing a CBF based on the safety control parameter range of the safe rotation angle and the safety control parameter range of the safe rotational angular velocity; and finally invoking the preset dynamics model to determine the safety constraint conditions for the to-be-controlled robot based on the CBF.

Herein, there are also a plurality of CBFs, and the plurality of CBFs are determined based on the safety control parameter range of the safe rotation angle in the safety control parameter and the safety control parameter range of the safe rotational angular velocity. For example, it is assumed that the safety control parameter range of the safe rotation angle q is between ±π/4, and the safety control parameter range of the safe rotational angular velocity \dot{φ} is between ±π/12. In this case, the plurality of CBFs may be

$$- φ + \frac{π}{4} , - φ + \frac{π}{4} , \dot{φ} + \frac{π}{12} , and - \dot{φ} + \frac{π}{12} .$$

In some embodiments, invoking the preset dynamics model to determine the safety constraint conditions for the to-be-controlled robot based on the plurality of CBFs may be implemented in the following manner: first, converting the preset dynamics model into a first dynamics model, where the first dynamics model may also be referred to as a simplified dynamics model; then determining a first control parameter and a second control parameter based on the first dynamics model and the current state parameter, and determining a first Lie derivative of the first control parameter and a second Lie derivative of the second control parameter based on the first control parameter, the second control parameter, and the CBFs; and finally determining the safety constraint conditions based on the first Lie derivative, the second Lie derivative, and the CBFs.

Herein, the first Lie derivative of the first control parameter includes a first-order Lie derivative and a second-order Lie derivative of the first control parameter, and the second Lie derivative of the second control parameter includes a first-order Lie derivative and a second-order Lie derivative of the second control parameter. The plurality of safety constraint conditions may be formed by separately substituting the first Lie derivative, the second Lie derivative, and the plurality of CBFs into a general constraint condition.

Operation S213: The server transmits the robot control result at the current moment to the terminal.

Operation S214: The terminal outputs the robot control result at the current moment.

In this embodiment of the present disclosure, first, the preset dynamics model is converted into the state space model, the state regulator is invoked to determine the state feedback parameter of the to-be-controlled robot, and then the basic control parameter of each joint is determined based on the state feedback parameter and the current state parameter. Then, the CBF is constructed based on the preset control input parameter and the basic control parameter, and a corresponding safety control parameter of each joint in a case that the safety objective function obtains the minimum value is determined based on the constraint condition in the CBF. Finally, during solving of the motion control parameter of each joint, the plurality of safety constraint conditions are added, the first motion control parameter of each joint is obtained through solving, and a corresponding joint of the to-be-controlled robot is controlled at the current moment by using the first motion control parameter. In this way, the safety control parameter of each joint is an optimized parameter obtained through optimization. The basic control parameter of each joint of the to-be-controlled robot is optimized by using the CBF to obtain the safety control parameter, and the first motion control parameter of each joint is determined by combining the safety control parameter with the plurality of safety constraint conditions. In this way, under strong external interference, effective safety control can still be implemented on the to-be-controlled robot by using the first motion control parameter, to improve robustness of the robot system.

The following describes exemplary application of the embodiments of the present disclosure in an actual application scenario.

The embodiments of the present disclosure provide a robot control method. A to-be-controlled robot in the method has the following features: Hip rotation centers of two legs are on a same plane or are coaxial. Each leg can independently extend and retract. Each leg has an independently driven wheel at the bottom. The robot has a plurality of legs. In addition, the robot further includes a waist rotatable in at least two directions, multi-degree-of-freedom upper limbs, and a head, and the upper limbs are distributed on two sides of a torso. The robot has very high universality, and may be applied to a plurality of scenarios, including elderly services, retail tallying, industrial manufacturing, intelligent inspection, and the like.

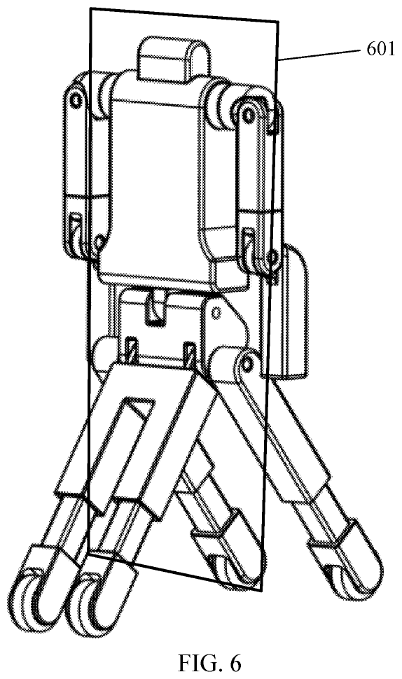

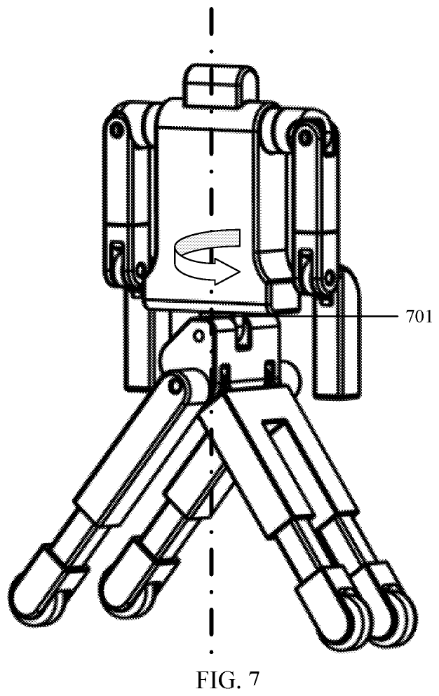

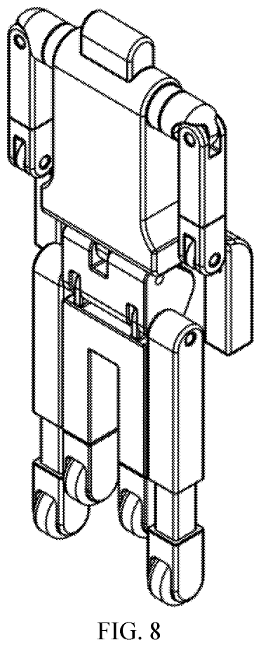

As shown in FIG. 5, the robot includes the following parts: a wheel 501, a leg portion (including an inner leg 5021 and an outer leg 5022), a waist 503, a torso 504, upper limbs 505, and a head 506. The wheel 501 is installed at an end of each leg, and each wheel 501 may be independently driven. Each leg may independently extend and retract along an extension/retraction direction 507 shown in FIG. 5. Two inner legs may rotate around a hip rotation center 508 and remain linked. Two outer legs may also rotate around a hip rotation center 508 and remain linked. The two hip rotation centers 508 of the inner leg 5021 and the outer leg 5022 are independently driven, but are on a same vertical plane 601. FIG. 6 shows one design in which the two hip rotation centers of the inner leg 5021 and the outer leg 5022 are coaxial. An upper end of the leg portion is connected to the waist of the robot. The waist has two rotation centers, including a pitch rotation center 509 and a lateral sway rotation center (a lateral sway rotation center 701 shown in FIG. 7) that can enable the torso to implement pitching and lateral swaying. The lateral sway rotation center 701 remains in a series design with the pitch rotation center 509, is above the pitch rotation center 509, and is connected to the torso of the robot. At an upper end of the torso of the robot, a multi-degree-of-freedom upper limb is connected to each of two sides of the head and the torso. In some designs, an end of the upper limb may alternatively be connected to a gripper.

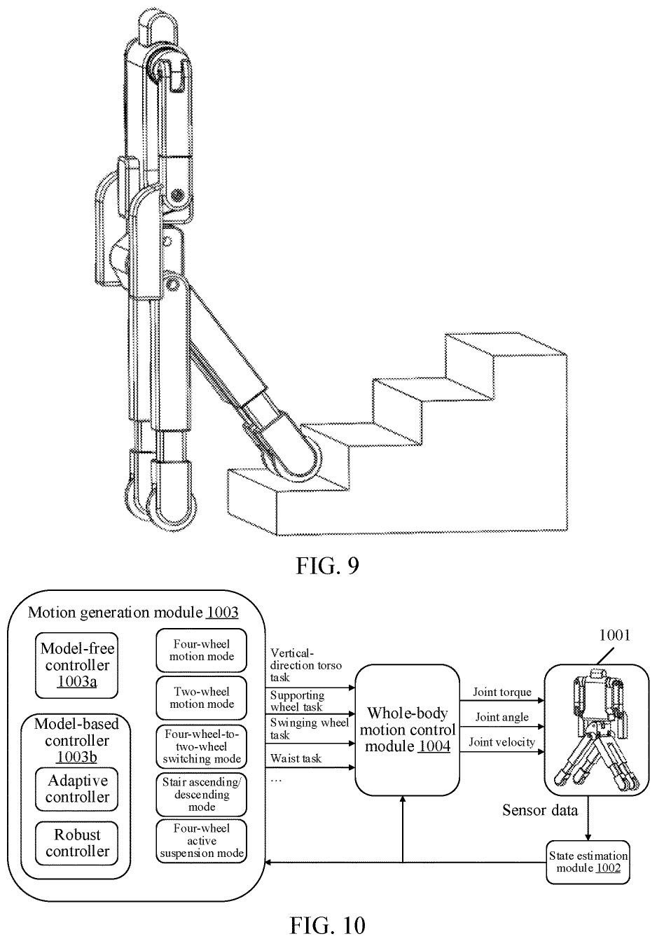

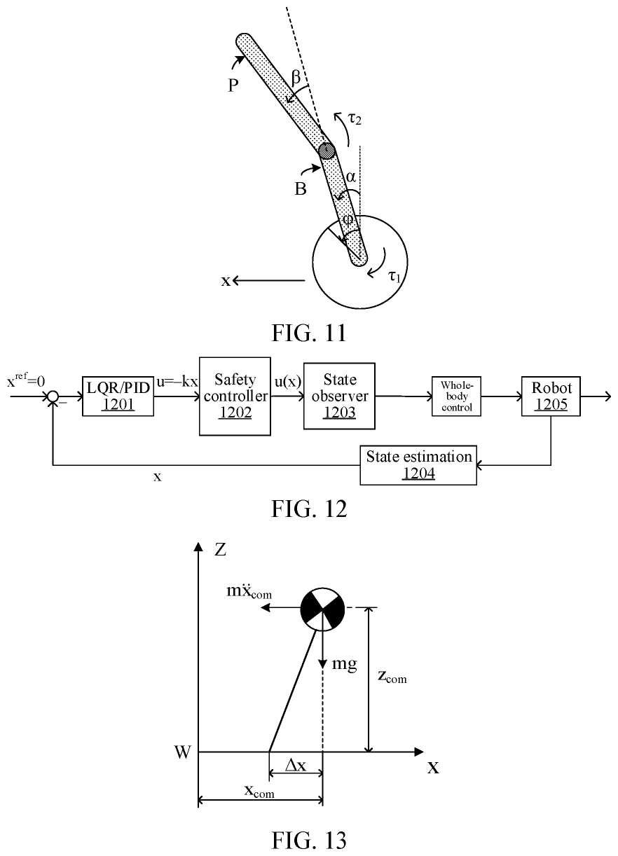

When moving on a flat ground, the robot may remain in a four-wheel mode shown in FIG. 7, or may rotate based on the lateral sway rotation center 701 at the hip, to form a two-wheel dynamic smooth motion mode shown in FIG. 8. In a four-wheel motion mode, the robot remains in a steady state (a non-falling state), so that the upper limbs can follow an instruction of an operator to perform some operation tasks. In addition, when moving on the flat ground, the robot switches from the four-wheel mode to the two-wheel mode, so that a floor area can be reduced, to match a bipedal humanoid robot. When moving on a non-flat ground, for example, typically, on steps or stairs, the robot may dynamically cross an obstacle in a two-wheel alternate mode shown in FIG. 9.

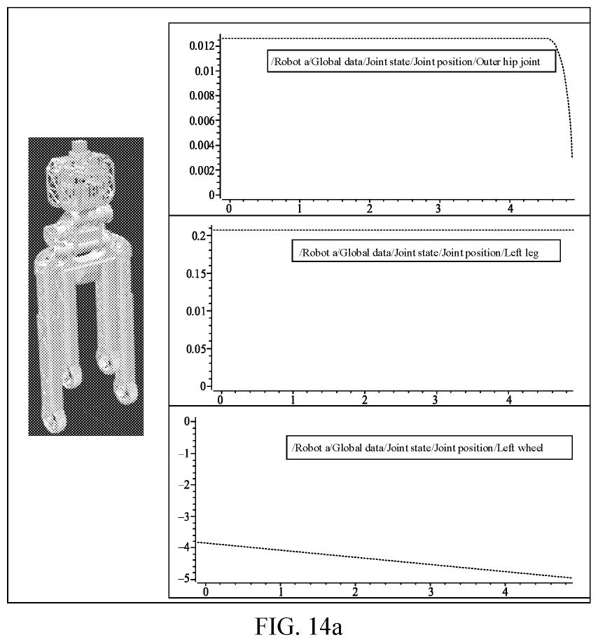

Based on the foregoing robot body, a block diagram of a built robot control system provided in the embodiments of the present disclosure is shown in FIG. 10. A rightmost picture 1001 represents a robot body. Four wheels of the robot are independently driven by four rotary motors. Lengths of four legs are independently driven by four linear motors. The four legs may be classified into two inner linkage legs and two outer linkage legs. The two inner linkage legs are driven by a same rotary motor, and the two outer linkage legs are driven by a same rotary motor. In addition, joints of a waist and an upper body of the robot are driven by rotary motors. All of the rotary motors described above may receive a rotation angle instruction, a rotational velocity instruction, and a rotation torque instruction. An underlying drive board of the rotary motor drives, based on a received instruction signal and in response to the instruction signal, the rotary motor to rotate. For all of the linear motors described above, the linear motor may receive a linear moving position instruction, a linear moving speed instruction, and a driving force instruction. An underlying drive board of the linear motor drives, based on a received instruction signal, the motor to move linearly. Rotation and movement of the rotary motor and the linear motor change a pose of the robot and a position of the robot in three-dimensional space, to control the robot. A quickly changing joint angle is configured to instruct the robot to cooperate, and may further cause a highly dynamic change in the pose of the robot, to change contact between the robot and an environment.

A state of the robot may be obtained by different sensors installed on the body. For example, a current pose of the robot may be obtained by using an inertial sensor; rotation and moving position and velocity information of each joint of the robot in a current state may be obtained by using a motor encoder; a magnitude and a direction of a force/torque applied to a joint, at which a sensor is located, at a current moment may be obtained by using a force sensor/torque sensor; pressure on the sole of a foot, a body surface, a hand, and even a fingertip of the robot and a change feature of the pressure within a period of time may be obtained by using a tactile sensor; and an obstacle in a field of view of the robot is recognized by using a visual sensor such as a camera, to indirectly obtain state information of the robot.

A function of a state estimation module 1002 is to fuse all pose and state information obtained by the robot, for example, fuse a current pose of the robot that is obtained by the inertial sensor, range information obtained based on rotation of a wheel, and visual positioning information, to obtain an accurate and trusted position of the robot in a world coordinate system; obtain a status of contact between the robot and an external environment based on the force sensor/torque sensor and the tactile sensor; and fuse the current pose of the robot that is obtained by the inertial sensor and angle information of all joint motor encoders, and combine a fusion result with a model parameter of the robot to estimate a COM position of the robot. The state information, obtained through fusion, of the robot is used as a feedback quantity for motion generation, planning, and control of the robot.

A module on the left in FIG. 10 is a motion generation module 1003. The motion generation module 1003 has different motion generation policies depending on different states of motion completed by the robot. An operating mode of the robot includes but is not limited to a four-wheel motion mode, a two-wheel motion mode, a four-wheel-to-two-wheel switching mode, a stair ascending/descending mode, a four-wheel active suspension mode, and a folded mode. In view of complexity of the upper body, the upper body may be configured to complete a plurality of types of tasks, and the robot can include more motion modes, which are not enumerated herein.

Motion generation manners in different modes are different. Some common basic technology and algorithm modules are invoked in these modes. These modules are listed in a leftmost column in FIG. 10, and include but are not limited to a model-free controller 1003a and a model-based controller 1003b (for example, an LQR, an MPC controller, an adaptive controller, and a robust controller). For example, a balance between wheels needs to be controlled in the two-wheel mode. In this case, a model-free PID controller may be used to generate a reference trajectory of the wheels and the CoM of the robot. A specific method may be invoking one or more of the model-free controller, the model-based controller (for example, the LQR and the MPC controller), the adaptive controller, and the robust controller. A similar control module is also needed in a two-wheel control stage in the four-wheel-to-two-wheel switching mode. In the four-wheel mode, if equivalence is made between a wheel leg extending toward the front of the body and a wheel leg extending toward the rear of the body, dynamics of the equivalent wheel leg and the upper body may be described by using a first-order or second-order inverted pendulum. In this part, the foregoing modules applied to balance control may also be invoked. A control trajectory obtained in this way can keep a balance of the robot in a four-wheel state. When a road surface is uneven or has a hole or an obstacle, a motion generated by a similar controller can make the upper body of the robot relative stable. This is also an implementation of a four-wheel active suspension function.

The motion generation module 1003 obtains a series of task information of the robot. The task information includes but is not limited to a CoM task, a supporting leg task, a swinging leg task, a waist task, and the like. Similarly, in view of complexity of the upper body, the upper body may be configured to complete a plurality of types of motion and tasks, and the robot can include more tasks, which are not enumerated herein. These tasks are inputted to a whole-body motion control module 1004. In the whole-body motion control module 1004, the robot is specifically modeled and calibrated, and a target joint angle instruction, a target joint angular velocity instruction, and a target joint torque instruction of each joint of the robot are calculated through an optimization process by using a dynamics model of the robot and an external force bearing status as constraint conditions for optimization. Finally, the target joint angle instruction, the target joint angular velocity instruction, and the target joint torque instruction of each joint are transmitted to each joint drive of the robot, to complete closed-loop control on the robot.

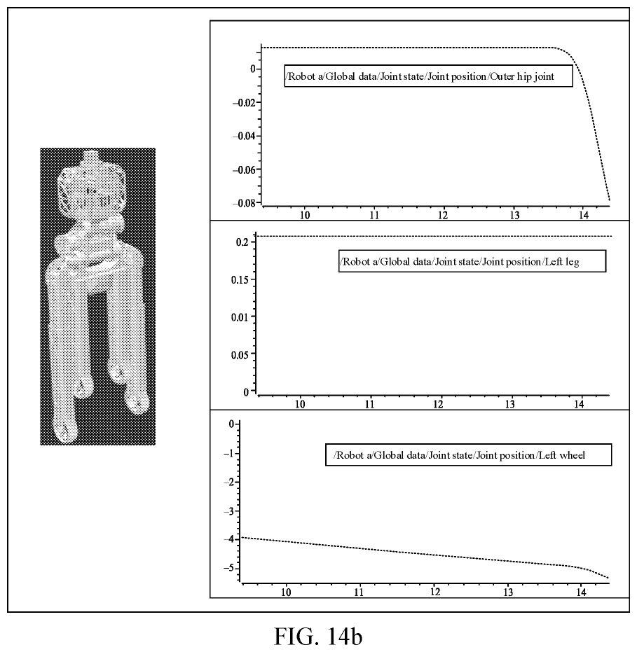

Herein, before operations of the balance control method provided in the embodiments of the present disclosure are described, a method for establishing a dynamics model corresponding to the balance control method provided in the embodiments of the present disclosure is first described. FIG. 11 is a diagram of a second-order inverted pendulum according to an embodiment of the present disclosure. To implement a balance control method for a wheel-legged robot, dynamics of the wheel-legged robot needs to be modeled to obtain a dynamics model of the wheel-legged robot during balance control. For clarity and brevity of description and ease of understanding, it is assumed that lengths of at least one leg mechanism included in the wheel-legged robot are equal, included angles between the at least one leg mechanism and the ground are equal, and rotational velocities and positions of all mobility wheels are the same. A world coordinate system is established by using a heading direction of the wheel-legged robot as a positive x-axis direction, using a rightward moving direction as a positive y-axis direction, and using an upward direction perpendicular to a contact surface as a positive z-axis direction. When the wheel-legged robot is observed from a y-axis direction, it is observed that the at least one leg mechanism of the wheel-legged robot coincides with each other. The at least one leg mechanism may be an outer leg mechanism of the wheel-legged robot, or may be all leg mechanisms of the wheel-legged robot.

For example, length changes of four leg mechanisms of the wheel-legged robot are synchronous, and angles between the four leg mechanisms and a base of the wheel-legged robot are synchronous. When observed from a direction corresponding to a y-axis, the four leg mechanisms coincide with each other, and four mobility wheels also coincide with each other. In this case, on a y-z plane in the world coordinate system, an abstract two-dimensional model of the wheel-legged robot is shown in FIG. 11. The two-dimensional model is a second-order inverted pendulum model. The second-order inverted pendulum model includes a mobility wheel, a link B (corresponding to at least one mobility leg of the wheel-legged robot), and a link P (corresponding to a torso mechanism of the wheel-legged robot). As shown in FIG. 11, in the two-dimensional model, a direction in which the mobility wheel rotates to a left side of the contact surface is used as a positive direction, a traveling distance is x, an angle by which the mobility wheel rotates relative to the world coordinate system is defined as φ, and a counterclockwise direction is used as a positive direction of a rotation angle of the mobility wheel. An angle by which the link B formed through coincidence of the four leg mechanisms rotates relative to the world coordinate system is defined as α, and a counterclockwise direction is a positive direction. An angle by which the link P corresponding to the torso mechanism rotates relative to the world coordinate system is defined as β, and a counterclockwise direction is used as a positive direction of a rotation angle of the mobility wheel.

\dot{φ}, \dot{α}, and \dot{β} are respectively defined as derivatives of φ, α, and β with respect to time, where \dot{φ} represents a rotational velocity of the mobility wheel (also referred to as an angle of the mobility wheel), \dot{α} represents an angular velocity of the leg mechanism, and \dot{β} represents an angular velocity of the torso mechanism. \ddot{φ}, \ddot{α}, and \ddot{β} are respectively defined as second-order derivatives of φ, α, and β with respect to time, where \ddot{φ} represents an angular acceleration of the mobility wheel, \ddot{α} represents an angular acceleration of the leg mechanism, and \ddot{β} represents an angular acceleration of the torso mechanism. The angle by which the mobility wheel rotates relative to the world coordinate system is driven by a joint motor on a first joint, a rotation torque of the first joint is denoted as τ₁, and a clockwise direction is used as a positive direction of the rotation torque of the first joint. The angle by which the torso mechanism rotates relative to the world coordinate system is driven by a joint motor on a second joint, a rotation torque of the second joint is denoted as τ₂, and a counterclockwise direction is used as a positive direction of the rotation torque of the second joint. Mass of the mobility wheel, mass of the link B (equivalent to at least one coinciding leg mechanism), and mass of the link P (equivalent to the torso mechanism) are respectively denoted as m_{W}, m_{B}, and m_{P}. Rotational inertia of the mobility wheel, rotational inertia of the link B, and rotational inertia of the link P are respectively denoted as J_{W}, J_{B}, and J_{P}. A radius of the mobility wheel is denoted as r, and a length of the link B is denoted as L_{B}. A length of a connection line from an intersection point of the link B and the mobility wheel to a geometric center of the link B is denoted as l_{B}. A length of a connection line from the intersection point of the link B and the wheel to a geometric center of the link P is denoted as l_{P}.

Based on the definitions of the foregoing physical quantities, first, expressions of total kinetic energy T_{W} of the mobility wheel, total kinetic energy T_{B} of the link B, and total kinetic energy T_{P} of the link P are separately derived, and total system kinetic energy T of the wheel-legged robot is obtained. Kinetic energy calculation for the total kinetic energy T_{W} of the mobility wheel, the total kinetic energy T_{B} of the link B, and the total kinetic energy T_{P} of the link P includes both translational kinetic energy and rotational kinetic energy, and total kinetic energy of a mobility wheel. The expressions of the total kinetic energy T_{W} of the mobility wheel, the total kinetic energy T_{B} of the link B, and the total kinetic energy T_{P} of the link P are shown in formulas (1) to (4).

$${T}_{W} = \frac{1}{2} {{m}_{w} ( \dot{φ} r )}^{2} + \frac{1}{2} {{J}_{w} ( \dot{φ} )}^{2} \qquad ( 1 )$$

$${T}_{B} = \frac{1}{2} {{m}_{B} ( \dot{φ} r + {l}_{B} \dot{α} cos α )}^{2} + \frac{1}{2} {{m}_{B} ( {l}_{B} \dot{α} sin α )}^{2} + \frac{1}{2} {J}_{B} {\dot{α}}^{2} \qquad ( 2 )$$

$${T}_{P} = \frac{1}{2} {{m}_{P} ( \dot{φ} r + {L}_{B} \dot{α} cos α + {l}_{P} ( \dot{α} + \dot{β} ) cos ( α + β ) )}^{2} + \frac{1}{2} {{m}_{P} ( {L}_{B} \dot{α} sin α + {l}_{P} ( \dot{α} + \dot{β} ) sin ( α + β ) )}^{2} + \frac{1}{2} {{J}_{P} ( \dot{α} + \dot{β} )}^{2} \qquad ( 3 )$$

$$T = {T}_{W} + {T}_{B} + {T}_{P} \qquad ( 4 )$$

Then, partial derivatives of the total system kinetic energy T of the robot with respect to each degree of freedom (α, β, φ) in generalized coordinates and a derivative of each degree of freedom are calculated, and a derivative, with respect to time, of a result of calculating a partial derivative with respect to the derivative of each degree of freedom is calculated. A specific process is shown in a formula (5).

$$\{ \begin{matrix}\frac{\partial T}{\partial φ} = 0 \\ \frac{\partial T}{\partial α} = - {L}_{B} {m}_{P} r \dot{φ} \dot{α} sin α - {l}_{B} {m}_{B} r \dot{φ} \dot{α} sin α - {l}_{P} {m}_{P} r \dot{φ} ( \dot{α} + \dot{β} ) sin ( α + β ) \\ \frac{\partial T}{\partial β} = - {l}_{P} {m}_{P} ( r \dot{φ} sin ( α + β ) + {L}_{B} \dot{α} sin β ) ( \dot{α} + \dot{β} )\end{matrix} \qquad ( 5 )$$

Then, total system potential energy U is calculated. A calculation expression for the total system potential energy U is shown in a formula (6).

$$U = g {m}_{P} ( {l}_{P} cos ( α + β ) + {L}_{B} cos α ) + g {l}_{B} {m}_{B} cos α \qquad ( 6 )$$

In the formula (6), a plane on which a mobility wheel is located is used as a zero-potential-energy plane, in other words, it is considered that potential energy of the mobility wheel is 0. The foregoing formula for the total system potential energy U does not include potential energy of the mobility wheel. Certainly, another potential energy plane may alternatively be selected. This does not affect implementation of the balance control method. A potential energy plane used during calculation of the total system potential energy is not limited in this embodiment of the present disclosure.

Then, a partial derivative of the total system potential energy U with respect to each degree of freedom in the generalized coordinates is calculated. Then, a dynamics equation of the wheel-legged robot in the second-order inverted pendulum model may be derived based on a Euler-Lagrange equation by using the foregoing formulas (1) to (6), as shown in the following formulas (7) to (9).

$$\{ \begin{matrix}{m}_{φφ} = {J}_{W} + {m}_{B} {r}^{2} + {m}_{P} {r}^{2} + {m}_{W} {r}^{2} \\ {m}_{φα} = {l}_{B} {m}_{B} r cos α + {L}_{B} {m}_{P} r cos α + {l}_{P} {m}_{P} r cos ( α + β ) \\ {m}_{φβ} = {l}_{P} {m}_{P} r cos ( α + β ) \\ {m}_{αα} = {J}_{B} + {J}_{P} + {L}_{B}^{2} {m}_{P} + {l}_{B}^{2} {m}_{B} + {l}_{P}^{2} {m}_{P} + 2 {L}_{B} {l}_{P} {m}_{P} cos β \\ {m}_{a β} = {J}_{P} + {l}_{P}^{2} {m}_{P} + {L}_{B} {l}_{P} {m}_{P} cos β \\ {m}_{β β} = {J}_{P} + {l}_{P}^{2} {m}_{P}\end{matrix} \qquad ( 7 )$$

$$\{ \begin{matrix}{C}_{φ} = - ( {l}_{P} {m}_{P} r sin ( α + β ) + {l}_{B} {m}_{B} r sin α + {L}_{B} {m}_{P} r sin α ) {\dot{α}}^{2} \\ - {l}_{P} {m}_{P} r sin ( α + β ) {\dot{β}}^{2} - 2 {l}_{P} {m}_{P} r sin ( α + β ) \dot{α} \dot{β} \\ {C}_{α} = - {L}_{B} {l}_{P} {m}_{P} sin β {\dot{β}}^{2} - 2 {L}_{B} {l}_{P} {m}_{P} sin β \dot{β} \dot{α} \\ {C}_{β} = {L}_{B} {l}_{P} {m}_{P} sin β {\dot{α}}^{2}\end{matrix} \qquad ( 8 )$$

$$\{ \begin{matrix}{g}_{φ} = 0 \\ {g}_{α} = - g {l}_{P} {m}_{P} sin ( α + β ) - {L}_{B} g {m}_{P} sin α - g {l}_{B} {m}_{B} sin α \\ {g}_{β} = - g {l}_{P} {m}_{P} sin ( α + β )\end{matrix} \qquad ( 9 )$$

The dynamics equation may be written in a polynomial form, as shown in the following formulas (10) and (11).

$$\{ \begin{matrix}{m}_{φφ} \ddot{φ} + {m}_{φα} \ddot{α} + {m}_{φβ} \ddot{β} + {c}_{φ} = {τ}_{1} \\ {m}_{φα} \ddot{φ} + {m}_{αα} \ddot{α} + {m}_{αβ} \ddot{β} + {c}_{α} + {g}_{α} = - {τ}_{1} \\ {m}_{φβ} \ddot{φ} + {m}_{αβ} \ddot{α} + {m}_{ββ} \ddot{β} + {c}_{β} + {g}_{β} = {τ}_{2}\end{matrix} \qquad ( 10 )$$

$$M ( α , β ) [ \begin{matrix}\ddot{φ} \\ \ddot{α} \\ \ddot{β}\end{matrix} ] + C ( α , β , \dot{α} , \dot{β} ) + G ( α , β ) = [ \begin{matrix}{τ}_{1} \\ - {τ}_{1} \\ {τ}_{2}\end{matrix} ] \qquad ( 11 )$$

M(α,β) is a 3×3 inertia matrix, and may include, for example,

$$[ \begin{matrix}{m}_{φφ} & {m}_{φα} & {m}_{φβ} \\ {m}_{φα} & {m}_{αα} & {m}_{αβ} \\ {m}_{φβ} & {m}_{αβ} & {m}_{ββ}\end{matrix} ] .$$

Elements mᵢⱼ (i∈(φ,α,β) and j∈(φ,α,β)) in M(α,β) are elements in the inertia matrix, and are configured for representing mass and rotational inertia of each joint rigid body included in the wheel-legged robot, and an equivalent inertial physical quantity of each mechanism under mutual impact when a deflection angle of the leg mechanism is α and a deflection angle of the torso mechanism is β·C(α,β, \dot{α},\dot{β}) is a 3×1 bias force matrix, which may also be referred to as a bias force vector; may include, for example, [c_{φ} c_{α} c_{β}]^{T}; and is configured for representing a Coriolis force and a centripetal force applied to each mechanism of the wheel-legged robot. G(α,β) represents a 3×1 gravity matrix, which may also be referred to as a gravity vector, and may include, for example, [0 g_{α} g_{β}]^{T}.

After the dynamics equation in the matrix form is derived through the foregoing process, the dynamics equation in the matrix form may be directly used during subsequent balance control, and the foregoing derivation process does not need to be repeated during balance control. The following describes the operations of the balance control method in the embodiments of the present disclosure.

First, a state quantity of a wheel-legged robot at a first moment is obtained, the state quantity at the first moment being configured for representing a motion state of the wheel-legged robot at the first moment.

In some embodiments, the first moment is any moment (which may be, for example, the current moment in the foregoing embodiments) during movement of the wheel-legged robot. At the first moment, included angles between at least one leg mechanism of the wheel-legged robot and a direction perpendicular to a contact surface are equal, rotational angular velocities of mobility wheels respectively corresponding to leg mechanisms are equal, rotation angles of at least one first joint for connecting a leg mechanism to a mobility wheel are equal, and rotational angular velocities of the at least one first joint are equal. That is, when observed from a side of the wheel-legged robot, the at least one leg mechanism coincides with each other, and at least one mobility wheel coincides with each other. The balance control method is implemented based on the wheel-legged robot being abstracted into a second-order inverted pendulum model.

In some embodiments, the state quantity (namely, the current state parameter) is configured to describe the motion state of the wheel-legged robot at the first moment. A pose and a motion velocity of the wheel-legged robot at the first moment can be determined based on the state quantity at the first moment. The state quantity at the first moment is obtained by observing the motion state of the wheel-legged robot by a sensor on the wheel-legged robot.

For example, the state quantity at the first moment includes at least one of the following: a deflection angle α of the leg mechanism, a deflection angle β of a torso mechanism, an angular velocity \dot{φ} of the mobility wheel, an angular velocity \dot{α} of the leg mechanism, and an angular velocity \dot{β} of the torso mechanism.

Physical quantities included in the state quantity are observed in a world coordinate system. The deflection angle α of the leg mechanism is a deflection angle of the leg mechanism relative to a z-axis in the world coordinate system. The deflection angle β of the torso mechanism is a deflection angle of the torso mechanism relative to the z-axis in the world coordinate system. The angular velocity \dot{φ} of the mobility wheel is a rotational velocity of the mobility wheel in an x-axis direction in the world coordinate system. The angular velocity a of the leg mechanism is configured for representing a change speed of the deflection angle of the leg mechanism. The angular velocity \dot{β} of the torso mechanism is configured to represent a change speed of the deflection angle of the torso mechanism.

The physical quantities in the state quantity may alternatively be determined based on relative positions between mechanisms of the wheel-legged robot. For example, the deflection angle α of the leg mechanism is a deflection angle of the leg mechanism relative to the z-axis in the world coordinate system, and the deflection angle β′ of the torso mechanism is a deflection angle of the torso mechanism relative to the leg mechanism, that is, β=α+β′ (positive directions of β′ and β are the same). An observation coordinate system corresponding to each physical quantity in the state quantity may be determined according to an actual requirement. This is not limited herein in the present disclosure.

In this embodiment of the present disclosure, the physical quantities in the formulas are observed based on the world coordinate system. Certainly, the balance control method may alternatively be implemented by using physical quantities determined by using another observation coordinate system, and related formulas may be obtained through equivalent replacement based on the formulas provided in this embodiment of the present disclosure. Details are not described again.

In the second-order inverted pendulum model, leg mechanisms are considered as coinciding by default. Therefore, deflection angles and angular velocities of the at least one leg mechanism are the same, and rotational velocities of the at least one mobility wheel are also the same.

For example, the state quantity includes the deflection angle α of the leg mechanism, the deflection angle β of the torso mechanism, the angular velocity \dot{φ} of the mobility wheel, the angular velocity \dot{α} of the leg mechanism, and the angular velocity \dot{β} of the torso mechanism. The state quantity may be represented by a symbol ξ, and the state quantity ξ may be expressed as follows: ξ=[α, β, \dot{φ}, \ddot{α}, \dot{β}]^{T}.

In this case, obtaining the state quantity of the wheel-legged robot at the first moment includes: determining the deflection angle α of the leg mechanism and the deflection angle β of the torso mechanism by using an inertial sensor and a motor encoder; and determining the angular velocity \dot{φ} of the mobility wheel, the angular velocity \dot{α} of the leg mechanism, and the angular velocity \dot{β} of the torso mechanism by using the motor encoder.

In this embodiment of the present disclosure, clock cycles of inertial sensors and motor encoders in the wheel-legged robot are the same, or clock cycles of inertial sensors and motor encoders in the wheel-legged robot are in a multiple relationship, so that all of the physical quantities included in the state quantity can be physical quantities at the first moment. For specific content about the inertial sensor and the motor encoder, refer to the foregoing descriptions. Details are not described herein again.

After the state quantity of the wheel-legged robot at the first moment is obtained, the state quantity at the first moment being configured to represent the motion state of the wheel-legged robot at the first moment, a dynamics controller parameter may be determined based on a dynamics equation of the wheel-legged robot and the state quantity at the first moment. The dynamics controller parameter is configured to define a mapping relationship between an angular acceleration at the first moment and a rotation torque at a second moment. The angular acceleration at the first moment includes the angular acceleration of the torso mechanism, an angular acceleration of the at least one leg mechanism, and the angular acceleration of the mobility wheel. The rotation torque at the second moment includes a rotation torque of the first joint and a rotation torque of a second joint.

In some embodiments, the angular acceleration at the first moment is a rotational acceleration of each mechanism of the wheel-legged robot (which may also be understood as an angular acceleration of a joint motor) after the wheel-legged robot is abstracted into the second-order inverted pendulum model. The angular acceleration at the first moment includes the angular acceleration \ddot{φ} of the mobility wheel, the angular acceleration \ddot{α} of the leg mechanism, and the angular acceleration \ddot{β} of the torso mechanism.

It can be learned from the foregoing content that, after the wheel-legged robot is abstracted into the second-order inverted pendulum model, a dynamics equation in a matrix form can be obtained. A process of determining the dynamics controller parameter is described below by using several embodiments. Operations of the process may be performed by the foregoing electronic device.

Determining the dynamics controller parameter based on the dynamics equation of the wheel-legged robot and the state quantity at the first moment in the foregoing embodiments may include the following several operations: First, substitute the state quantity at the first moment into the dynamics equation to determine an inertia matrix, a bias force matrix, and a gravity matrix at the first moment by using the dynamics equation, the inertia matrix being configured for representing mass and rotational inertia of each joint rigid body of the wheel-legged robot at the first moment, the bias force matrix being configured for representing a bias force of the wheel-legged robot at the first moment, and the gravity matrix being configured for representing gravity of the wheel-legged robot at the first moment. Then, determine the dynamics controller parameter based on the inertia matrix, the bias force matrix, and the gravity matrix.

The inertia matrix is configured for representing inertial quantities of joint rigid bodies (including the first joint and the second joint) of the wheel-legged robot in a pose at the first moment. The inertia matrix includes mass and rotational inertia. The inertia matrix may be calculated based on the dynamics equation. When the wheel-legged robot is abstracted into the second-order inverted pendulum model, the inertia matrix is a 3×3 matrix. The bias force matrix is configured for representing a Coriolis force and a centripetal force applied to each mechanism. For example, the bias force matrix includes a bias force caused by the deflection angle of the mobility wheel, a bias force caused by the deflection angle of the leg mechanism, and a bias force caused by the deflection angle of the torso mechanism. The gravity matrix is configured for representing gravity applied to each mechanism. In some embodiments, the gravity matrix may include gravity applied to the mobility wheel, gravity applied to the leg structure, and gravity applied to the torso mechanism. In this embodiment of the present disclosure, it can be assumed by default that the mobility wheel (for example, a mobility wheel of an outer leg mechanism) is in contact with a contact surface. During balance control, gravity applied to the mobility wheel due to mass of the mobility wheel remains unchanged. Therefore, a plane on which a CoM of the mobility wheel is located is used as a zero-potential-energy plane, and the gravity applied to the mobility wheel is zero, to reduce calculation overheads during balance control. For related content about the inertia matrix, the bias force matrix, and the gravity matrix, refer to the foregoing descriptions. Details are not described herein again.

Expressions of elements in the inertia matrix, the bias force matrix, and the gravity matrix are also pre-derived based on the dynamics formula. After the state quantity at the first moment is determined, specific values of elements included in the inertia matrix, the bias force matrix, and the gravity matrix at the first moment may be calculated based on predefined formulas, to obtain the inertia matrix, the bias force matrix, and the gravity matrix at the first moment.

In some embodiments, the dynamics controller parameter includes a ratio parameter matrix and an offset parameter matrix. The ratio parameter matrix is configured for representing a ratio relationship between the angular acceleration and the rotation torque at the first moment. The offset parameter matrix is configured for representing an offset relationship between the angular acceleration and the rotation torque at the first moment. The offset parameter matrix may be calculated by using a robust controller based on the inertia matrix, the bias force matrix, and the gravity matrix. Then the ratio parameter matrix is calculated based on the inertia matrix. The robust controller herein is a controller designed to ensure stability and performance of a robot system under various uncertainties and interferences. The robust controller can adapt to changes in parameters of the robot system, external disturbances, and model errors, to ensure that the robot system can reliably operate under different conditions.

The foregoing operation of determining the dynamics controller parameter based on the inertia matrix, the bias force matrix, and the gravity matrix further includes the following operations: First, separately perform matrix conversion on a product of an inverse matrix of the inertia matrix and the bias force matrix and a product of the inverse matrix of the inertia matrix and the gravity matrix by using a selection matrix to obtain the offset parameter matrix, the selection matrix herein being configured to extract the rotation torque of the first joint and the rotation torque of the second joint from the dynamics equation. Then, process the inverse matrix of the inertia matrix by using the selection matrix to obtain the ratio parameter matrix.

Based on the content of determining the dynamics controller parameter based on the dynamics equation of the wheel-legged robot and the state quantity at the first moment in the foregoing operation in the foregoing embodiments, the foregoing two operations of determining the dynamics controller parameter are described. First, partial feedback linearization may be performed on the dynamics equation in the matrix form. To be specific, matrix conversion is separately performed on the product of the inverse matrix of the inertia matrix and the bias force matrix and the product of the inverse matrix of the inertia matrix and the gravity matrix by using the selection matrix to obtain the offset parameter matrix, as shown in a formula (12).

$$[ \begin{matrix}\ddot{φ} \\ \ddot{α} \\ \ddot{β}\end{matrix} ] = - {M}^{- 1} ( α , β ) C ( α , β , \dot{α} , \dot{β} ) - {M}^{- 1} ( α , β ) G ( α , β ) + {M}^{- 1} ( α , β ) [ \begin{matrix}{τ}_{1} \\ - {τ}_{1} \\ {τ}_{2}\end{matrix} ] \qquad ( 12 )$$

M⁻¹ (α, β) is the inverse matrix of the inertia matrix, M⁻¹(α,β)*M(α,β)=E, and E is an identity matrix. For physical meanings of other parameters in the equation, refer to the foregoing embodiments. Details are not described herein again.

In some embodiments, to make the formula (12) include only τ₁ and τ₂ to simplify execution logic of subsequent operations and reduce a calculation amount of the robust controller, during design of the robust controller, the formula (12) further needs to be adjusted. The formula (12) is processed by using the selection matrix. To be specific, the inverse matrix of the inertia matrix is processed by using the selection matrix to obtain the ratio parameter matrix, as shown in a formula (13).

$$[ \begin{matrix}\ddot{φ} \\ \ddot{α} \\ \ddot{β}\end{matrix} ] = [ \begin{matrix}{f}_{1} ( ξ ) \\ {f}_{2} ( ξ ) \\ {f}_{3} ( ξ )\end{matrix} ] + [ \begin{matrix}{g}_{11} ( ξ ) & {g}_{12} ( ξ ) \\ {g}_{21} ( ξ ) & {g}_{22} ( ξ ) \\ {g}_{31} ( ξ ) & {g}_{32} ( ξ )\end{matrix} ] [ \begin{matrix}{τ}_{1} \\ {τ}_{2}\end{matrix} ] \qquad ( 13 )$$

$$[ \begin{matrix}{f}_{1} ( ξ ) \\ {f}_{2} ( ξ ) \\ {f}_{3} ( ξ )\end{matrix} ] = [ - {M}^{- 1} ( α , β ) C ( α , β , \dot{α} , \dot{β} ) - {M}^{- 1} ( α , β ) G ( α , β ) ] * {S}^{T} , and [ \begin{matrix}{f}_{1} ( ξ ) \\ {f}_{2} ( ξ ) \\ {f}_{3} ( ξ )\end{matrix} ]$$

is the foregoing offset parameter matrix f[ ]

$$[ \begin{matrix}{g}_{11} ( ξ ) & {g}_{12} ( ξ ) \\ {g}_{21} ( ξ ) & {g}_{22} ( ξ ) \\ {g}_{31} ( ξ ) & {g}_{32} ( ξ )\end{matrix} ] = {M}^{- 1} ( α , β ) * {S}^{T} , and [ \begin{matrix}{g}_{11} ( ξ ) & {g}_{12} ( ξ ) \\ {g}_{21} ( ξ ) & {g}_{22} ( ξ ) \\ {g}_{31} ( ξ ) & {g}_{32} ( ξ )\end{matrix} ]$$

is the foregoing ratio parameter matrix g[ ]. S^{T} is a transposed matrix of a matrix S, and the matrix S is a 3×2 selection matrix.

The formula (13) may be pre-designed after the wheel-legged robot is abstracted into the second-order inverted pendulum model. During implementation of the balance control method, after the state quantity at the first moment is obtained, the ratio parameter matrix and the offset parameter matrix may be calculated by the robust controller based on the formula (13) and the formula (7) to the formula (11).

In some embodiments, the dynamics equation of the robot is obtained through derivation based on the Euler-Lagrange equation after the wheel-legged robot is abstracted into the second-order inverted pendulum model. For a derivation process of the dynamics equation, refer to the foregoing embodiments. Details are not described herein again.

The following describes a design principle of a controller with a CBF that is provided in the embodiments of the present disclosure. In the embodiments of the present disclosure, the controller with the CBF may be combined with simplified model control, and the foregoing dynamics model may be written into a state space representation, as shown in a formula (14).

$$[ \begin{matrix}\dot{φ} \\ \dot{α} \\ \dot{β} \\ \ddot{φ} \\ \ddot{α} \\ \ddot{β}\end{matrix} ] = [ \begin{matrix}{0}_{3 \times 3} & {I}_{3 \times 3} \\ {A}_{21} & {A}_{22}\end{matrix} ] [ \begin{matrix}φ \\ α \\ β \\ \dot{φ} \\ \dot{α} \\ \dot{β}\end{matrix} ] + [ \begin{matrix}0 & 0 \\ 0 & 0 \\ 0 & 0 \\ {g}_{11} ( ξ ) & {g}_{12} ( ξ ) \\ {g}_{21} ( ξ ) & {g}_{22} ( ξ ) \\ {g}_{31} ( ξ ) & {g}_{32} ( ξ )\end{matrix} ] [ \begin{matrix}{τ}_{1} \\ {τ}_{2}\end{matrix} ] \qquad ( 14 )$$

0_{3×3} is a 3×3-dimensional zero matrix. I_{3×3} is a 3×3-dimensional identity matrix. A₂₁ and A₂₂ respectively represent two different system matrices.

Based on the space state representation, a feedback controller can be designed by using an LQR. An expression of the controller is shown in a formula (15).

$$u = - Kx \qquad ( 15 )$$

u is an original control policy used before a safety controller is applied. K represents a feedback matrix. x represents a state variable used for the feedback controller.

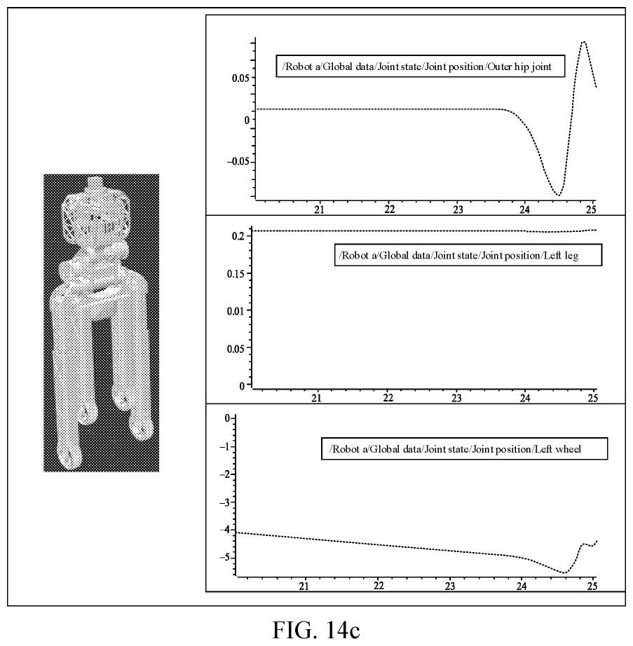

A schematic flowchart of robot system control is shown in FIG. 12. A safety controller 1202 is equivalent to a filter between an LQR/PID controller 1201 and an actual robot system. A state observer 1203 is connected after the safety controller 1202. Whole-body control is performed on a robot 1205 based on an output parameter of the state observer 1203. During whole-body control on the robot, state estimation 1204 is further cyclically performed on the robot to obtain a state parameter x. In this way, safe and stable movement of the robot can be ensured through a series of cyclical control in FIG. 12. In this embodiment of the present disclosure, an expression of the safety controller is shown in a formula (16).

$$u ( x ) = arg min \frac{1}{2} {‖ v - u ‖}^{2} v ∈ {ℝ}^{m} \qquad ( 16 )$$

$$s . t . {L}_{f} h ( x ) + {L}_{g} h ( x ) u \geq - α ( h ( x ) )$$

u(x) is a control policy, namely, an objective function, of the safety controller that is obtained through solving. v represents a decision variable, and belongs to an m-dimensional real number set. argmin represents a variable value that enables the objective function u(x) to obtain a minimum value. h(x) represents a safety boundary function, which may also be referred to as a CBF. L_{f}h(x) and L_{g}h(x) respectively represent two different first-order Lie derivative. α represents a class K function.

Then, there are two solutions. A solution 1 is robot control based on a simplified model. The original control policy u obtained in the formula (16) directly indicates a torque of a wheel and a torque of a hip joint. Therefore, the torques may be directly transmitted to the robot to control the robot. For control on other joints of the robot, position control may be performed based on a planned trajectory, or another solution may be used. Details are not described herein. An advantage of the method lies in that control is stable and is not affected by other joints. In a solution 2, a result of a simplified model is used as a reference for WBC, and the control policy u(x) of the safety controller that is obtained through solving is inputted to the state observer. In addition, a joint angle, an inertial position/pose, and the like at a current moment are further inputted to the state observer. Based on the information, the state observer may obtain a reference value of a difference between a projection of a robot COM on the ground and a projection of a wheel center on the ground at a next moment, that is, Δx^{r} in a formula (23), and a reference value of a velocity difference between the projection of the robot COM on the ground and the projection of the wheel center on the ground, that is, Δ\dot{x}^{r} in the formula (23). In this way, simplified model control is combined with WBC.

In this embodiment of the present disclosure, a method for establishing and controlling a whole-body dynamics model of the robot includes the following operations:

First, the whole-body dynamics model is established. A dynamics model of the robot in a joint space system may be constructed based on rigid body dynamics, as shown in the following formula (17).

$$H \ddot{q} + C = {S}^{T} τ + {J}_{c}^{T} f \qquad ( 17 )$$

H∈ [symbol] ^{N}^{_{G}}^{×N}^{_{G}} represents a joint space inertia matrix. C∈ [symbol] ^{N}^{_{G}} represents a joint space offset vector, that is, a sum of a Coriolis force, a centrifugal force, and gravity. S∈ [symbol] ^{N}^{_{J}}^{×N}^{_{G}} represents a selection matrix. J_{c}∈ [symbol] ^{N}^{_{C}}^{×N}^{_{G}} represents a contact point Jacobian matrix. τ∈ [symbol] ^{N}^{_{J}} represents an active joint torque vector. f∈ [symbol] ^{N}^{_{C}} represents a contact force vector. q, \dot{q}, \ddot{q}∈ [symbol] ^{N}^{_{G}} respectively represent a generalized position vector, a generalized velocity vector, and a generalized acceleration vector. N_{G} represents a total degree of freedom of the robot, to be specific, a sum of a floating base degree of freedom N_{F} and a degree of freedom N_{J} of an active joint. N_{C} represents a quantity of contact forces, to be specific, a product of a quantity n_{C} of contact points and a dimensionality N_{D} ∈{0, 1, 2, 3} of a single contact force.

After the whole-body dynamics model is established, an expected operation space task is calculated. The operation space task herein is an acceleration \ddot{x}ₜ in operation space. The expected operation space task is an expected acceleration \ddot{x}ₜ^{t} calculated by the feedback controller based on a reference trajectory and an actual state of the robot.

For example, an operation space task of dynamic stair ascending may include but is not limited to the following: a supporting wheel task, a vertical-direction torso task, a torso pose task, a swinging wheel task, and a CoM task.

For the supporting wheel task, a supporting wheel is expected to only roll, without sliding relative to the ground. Therefore, an expected acceleration of the supporting wheel is always zero. Refer to the following formula (18).

$${\ddot{x}}_{t , stance}^{d} = {0}_{{N}_{C} \times 1} \qquad ( 18 )$$

$${\ddot{x}}_{t , stance}^{d}$$

is the expected acceleration of the supporting wheel, and 0_{N}_{_{C}}_{×1} represents a N_{C}×1-dimensional zero matrix.

If the robot operates in a four-wheel mode, there are four supporting wheels, and each supporting wheel has a task in an x direction. If it is considered that the wheels do not leave the ground, heights of the wheels in a z direction are constant. Tasks of the four supporting wheels in the z direction are not considered. If left/right turning motion of the robot in the four-wheel mode and translational motion of the robot in a y direction are not considered, tasks of the four supporting wheels in the y direction may not be considered either.

If the robot operates in a two-wheel balanced mode, there are two supporting wheels, and there are other two swinging wheels. In this case, tasks of the supporting wheels are not considered, because a related task is already included in the “COM task” to ensure implementation of two-wheel balancing. In addition, tasks of the two swinging wheel include two dimensions: an x direction and a z direction. Similarly, if left/right turning motion of the robot in the two-wheel balanced mode and translational motion of the robot in the y direction are not considered, tasks of the two swinging wheels in the y direction may not be considered either. Task construction details are included in the “swinging wheel task”.

For the vertical-direction torso task, a reference position

$${x}_{t , base}^{r} ,$$

a reference velocity

$${\dot{x}}_{t , base}^{r} ,$$

and a reference acceleration

$${\ddot{x}}_{t , base}^{r}$$

of the torso in a vertical direction may be planned based on height information of a staircase surface and positions of the supporting wheels on stairs by using a spline interpolation method. An actual

$${x}_{t , base}^{a}$$

and an actual velocity

$${\dot{x}}_{t , base}^{a}$$

of the torso in the vertical direction may be calculated based on inertial and joint angle and angular velocity information by using forward kinematics. To improve robustness of the controller, a proportional-derivative (PD) feedback controller may be constructed. A vertical-direction expected acceleration of the torso is calculated by using the PD feedback controller. Refer to the following formula (19).

$${\ddot{x}}_{t , base}^{d} = {\ddot{x}}_{t , base}^{r} + {k}_{p , base} ( {x}_{t , base}^{r} - {x}_{t , base}^{a} ) + {k}_{d , base} ( {\dot{x}}_{t , base}^{r} - {\dot{x}}_{t , base}^{a} ) \qquad ( 19 )$$

$${\ddot{x}}_{t , base}^{d}$$

is the vertical-direction expected acceleration of the torso. kₚ, base represents a proportional coefficient of the torso in the vertical direction. k_{d,base} represents a derivative coefficient of the torso in the vertical direction.

For the torso pose task, during stair ascending, the torso of the robot remains upright as much as possible, and does not rotate on stairs. To be specific, reference trajectories, that is,

$${x}_{t , euler}^{r} = {0}_{3 \times 1} , {\dot{x}}_{t , euler}^{r} = {0}_{3 \times 1} , and {\ddot{x}}_{t , euler}^{r} = {0}_{3 \times 1} ,$$

of a Euler angle including a roll angle, a pitch angle, and a yaw angle of the torso are all zero. In addition, an actual angle

$${x}_{t , euler}^{a} , angular velocity {\dot{x}}_{t , euler}^{a} ,$$

and angular acceleration

$${\ddot{x}}_{t , euler}^{a}$$

of the Euler angle may be calculated based on inertial information. Similarly, the expected attitude angular acceleration of the torso may also be calculated by using the PD controller. Refer to the following formula (20).

$${\ddot{x}}_{t , euler}^{d} = {\ddot{x}}_{t , euler}^{r} + {k}_{p , euler} ( {x}_{t , euler}^{r} - {x}_{t , euler}^{a} ) + {k}_{d , euler} ( {\dot{x}}_{t , euler}^{r} - {\dot{x}}_{t , euler}^{a} ) \qquad ( 20 )$$

$${\ddot{x}}_{t , euler}^{d}$$

is the expected attitude angular acceleration of the torso. k_{p, euler} represents a proportional coefficient of a torso pose. k_{d, euler} represents a derivative coefficient of the torso pose.

The swinging wheel task is applicable to a scenario in which two swinging wheels move in a two-wheel balanced mode, for example, a scenario in which two swinging wheels need to present a specific pose and specific motion when two wheels run on the ground in balance, or switching occurs between a supporting wheel leg and a swinging wheel leg when two wheels step forward on the ground, or switching occurs between a supporting wheel leg and a swinging wheel leg when a step is taken during stair ascending/descending.

A reference position

$${x}_{t , swing}^{r} ,$$

a reference velocity

$${\dot{x}}_{t , swing}^{r} ,$$

and a reference acceleration

$${\ddot{x}}_{t , swing}^{r}$$

of the swinging wheel in operation space may be planned by using the spline interpolation method. An actual

$${x}_{t , swing}^{a}$$

and an actual velocity

$${\dot{x}}_{t , swing}^{a}$$

of the swinging wheel may be calculated based on inertial and joint angle and angular velocity information by using forward kinematics. The expected acceleration of the swinging wheel is also calculated by using the PD feedback controller. Refer to the following formula (21).

$${\ddot{x}}_{t , swing}^{d} = {\ddot{x}}_{t , swing}^{r} + {k}_{p , swing} ( {x}_{t , swing}^{r} - {x}_{t , swing}^{a} ) + {k}_{d , swing} ( {\dot{x}}_{t , swing}^{r} - {\dot{x}}_{t , swing}^{a} ) \qquad ( 21 )$$

$${\ddot{x}}_{t , swing}^{d}$$

is the expected acceleration of the swinging wheel. k_{p, swing} represents a proportional coefficient of the swinging wheel. k_{d, swing} represents a derivative coefficient of the swinging wheel.

For the CoM task, a reference position

$${x}_{t , com}^{r}$$

and a reference velocity

$${\dot{x}}_{t , com}^{r}$$

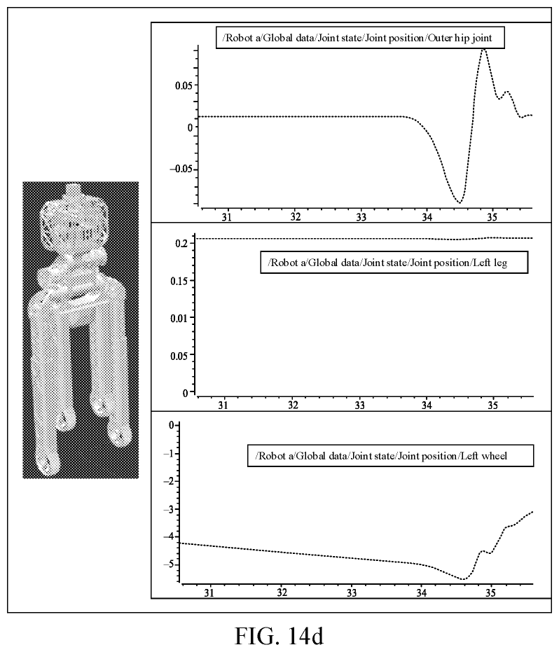

of the COM along a heading direction may be planned by using a heuristic or model-based method. During movement of the robot, the CoM not only needs to continuously move along the heading direction, but also needs to help the robot to achieve a dynamic balance. Therefore, a balance controller needs to be first constructed to calculate an expected acceleration of the COM. It is assumed that mass m of the robot is concentrated at the COM and a center of a connection line between two supporting wheels is a virtual contact point between an inverted pendulum and the ground. The COM is connected to the virtual contact point to construct an inverted pendulum model shown in FIG. 13. Then, a dynamics equation of the model needs to be constructed. Different from a general inverted pendulum dynamics equation, the inverted pendulum dynamics equation in this embodiment of the present disclosure is constructed by using a difference Δx between the COM and the virtual contact point, a COM position x_{com}, and derivatives Δ\dot{x} and \dot{x}_{com} thereof as state variables and using a CoM acceleration \ddot{x}_{com} as an input. Refer to the following formula (22).

$$\frac{d}{dt} [ \begin{matrix}Δ x \\ Δ \dot{x} \\ {x}_{c o m} \\ {\dot{x}}_{c o m}\end{matrix} ] = [ \begin{matrix}0 & 1 & 0 & 0 \\ 0 & 0 & 0 & 0 \\ 0 & 0 & 0 & 1 \\ g / {z}_{com} & 0 & 0 & 0\end{matrix} ] [ \begin{matrix}Δ x \\ Δ \dot{x} \\ {x}_{c o m} \\ {\dot{x}}_{c o m}\end{matrix} ] + [ \begin{matrix}0 \\ 0 \\ 0 \\ 1\end{matrix} ] {\ddot{x}}_{c o m} \qquad ( 22 )$$

g is a gravity acceleration, and z_{com} is a distance of the CoM in a z-axis direction.

Then, a state feedback gain matrix K of the formula (22) is calculated by using an LQR. Finally, an input for a state equation may be obtained based on the LQR controller, as shown in a formula (23).

$${\ddot{x}}_{c o m} = K ( [ \begin{matrix}Δ {x}^{r} \\ Δ {\dot{x}}^{r} \\ {x}_{c o m}^{r} \\ {\dot{x}}_{c o m}^{r}\end{matrix} ] - [ \begin{matrix}Δ {x}^{a} \\ Δ {\dot{x}}^{a} \\ {x}_{c o m}^{a} \\ {\dot{x}}_{c o m}^{a}\end{matrix} ] ) \qquad ( 23 )$$

$$[ \begin{matrix}Δ {x}^{r} \\ Δ {\dot{x}}^{r} \\ {x}_{c o m}^{r} \\ {\dot{x}}_{c o m}^{r}\end{matrix} ]$$

represents reference values of the state variables, and

$$[ \begin{matrix}Δ {x}^{a} \\ Δ {\dot{x}}^{a} \\ {x}_{c o m}^{a} \\ {\dot{x}}_{c o m}^{a}\end{matrix} ]$$

represents actual values of the state variables.

The CoM acceleration \ddot{x}_{com} calculated in the formula (23) is used as an expected COM acceleration

$${\ddot{x}}_{com}^{d} .$$

This can not only determine a reference trajectory of the COM, but also keep a dynamic balance of the robot.

To sum up, the expected operation space task for movement of the robot is expressed as the following formula (24).

$${\ddot{x}}_{t}^{d} = [ \begin{matrix}{\ddot{x}}_{t , contact}^{d} \\ {\ddot{x}}_{t , base}^{d} \\ {\ddot{x}}_{t , euler}^{d} \\ {\ddot{x}}_{t , swing}^{d} \\ {\ddot{x}}_{t , com}^{d}\end{matrix} ] \qquad ( 24 )$$

After the dynamics controller parameter is determined based on the dynamics equation of the wheel-legged robot and the state quantity at the first moment, a to-be-solved dynamics equation is constructed. It can be learned from rigid body dynamics that a relationship between an operation space acceleration \ddot{x}ₜ and a joint space velocity \dot{q} and acceleration \ddot{q} is shown in the following formula (25).

$${\ddot{x}}_{t} = {\dot{J}}_{t} \dot{q} + {J}_{t} \ddot{q} \qquad ( 25 )$$

Jₜ, \dot{J}ₜ represent a Jacobian matrix of the operation space task and a derivative of the Jacobian matrix.

The following formula (26) may be obtained by combining the formula (25) with the formula (17) and simplifying a combined formula:

$$[ \begin{matrix}H & - {S}^{T} & - {J}_{c}^{T} \\ {J}_{t} & {0}_{{N}_{T} \times {N}_{J}} & {0}_{{N}_{T} \times {N}_{C}}\end{matrix} ] [ \begin{matrix}\ddot{q} \\ τ \\ f\end{matrix} ] = [ \begin{matrix}- C \\ \begin{matrix}{\ddot{x}}_{t} & {\dot{J}}_{t} \dot{q}\end{matrix}\end{matrix} ] \qquad ( 26 )$$

The expected operation space task may be substituted into the formula (26) to obtain the to-be-solved dynamics equation, where

$$[ \begin{matrix}\ddot{q} \\ τ \\ f\end{matrix} ]$$

is a to-be-solved variable, and others are known quantities.

After the to-be-solved dynamics equation is constructed, a constraint condition may be added. For example, the following constraint conditions are set for the to-be-solved variable based on a body structure of the robot and a physical limitation of a motor: a physical joint constraint and a friction constraint.

For the physical joint constraint, a range of a torque t of an active joint in the to-be-solved variable may be limited based on physical characteristics of an actual motor of the robot, that is, τ_{lb}≤τ≤τ_{ub}, where τ_{lb}, τ_{ub} respectively represent a minimum value and a maximum value of a motor torque.

For the friction constraint, a contact force i of an fᵢ^{th} contact point is to meet a friction cone constraint. To reduce nonlinearity, a friction cone may be approximated as a friction pyramid to obtain a friction inequality constraint, as shown in the following formula (27).

$$[ \begin{matrix}- {μ}_{i} {n}_{z}^{T} \pm {n}_{x}^{T} \\ - {μ}_{i} {n}_{z}^{T} \pm {n}_{y}^{T} \\ - {n}_{z}^{T} \\ {n}_{z}^{T}\end{matrix} ] {f}_{i} \leq [ \begin{matrix}0 \\ 0 \\ - {f}_{z , lb} \\ {f}_{z , ub}\end{matrix} ] \qquad ( 27 )$$

nₓ, n_{y}, and n_{z} represent unit orthogonal bases along a contact surface in an operation space system. μᵢ represents a friction coefficient. f_{z, lb} and f_{z, ub} respectively represent a minimum value and a maximum value of non-negative positive pressure perpendicular to the contact surface.

After the constraint conditions are added, the dynamics equation is solved by using an optimizer. In this case, the formula (26) may be rewritten in a form of AX=B, where

$$A = [ \begin{matrix}H & - {S}^{T} & - {J}_{c}^{T} \\ {J}_{t} & {0}_{{N}_{T} \times {N}_{J}} & {0}_{{N}_{T} \times {N}_{C}}\end{matrix} ] , X = [ \begin{matrix}\ddot{q} \\ τ \\ f\end{matrix} ] , and B = [ \begin{matrix}- C \\ \begin{matrix}{\ddot{x}}_{t} & - {\dot{J}}_{t} \dot{q}\end{matrix}\end{matrix} ] .$$

The essence is solving a linear equation system. Herein, a QP optimizer is used to construct an objective function, as shown in the following formula (28).

$$J = {min ( A X - B )}^{T} Q ( A X - B ) + {X}^{T} R X \qquad ( 28 )$$

Q, R represents a weight matrix.

An appropriate QP optimizer is selected based on the foregoing constraint conditions, to calculate a minimum value of the formula (28), to obtain the to-be-solved variable

$$X = [ \begin{matrix}\ddot{q} \\ τ \\ f\end{matrix} ] .$$

Finally, the joint torque is delivered to the motor, to control the robot.

The following describes a combination of WBC and the controller with the CBF in the embodiments of the present disclosure.

Safety constraint conditions may be added to a WBC controller, and then a torque obtained through solving is transmitted to each joint of the robot to complete control. The embodiments of the present disclosure provide a process of deriving the safety constraint conditions. For a dynamics equation of the robot system, refer to the following formula (29).

$$M ( α , β ) [ \begin{matrix}\ddot{φ} \\ \ddot{α} \\ \ddot{β}\end{matrix} ] + C ( α , β , \dot{α} , \dot{β} ) + G ( α , β ) = {S}^{T} [ \begin{matrix}{τ}_{1} \\ {τ}_{2}\end{matrix} ] \qquad ( 29 )$$

If a CBF is applied to a simplified model, a state quantity may be selected as x=[φ, α, β, \dot{φ}, \dot{α}, \dot{β}]^{T}. In this case, the dynamics equation may be converted into the following formula (30). The formula (30) is the foregoing first dynamics model.

$$[ \begin{matrix}\dot{φ} \\ \dot{α} \\ \dot{β} \\ \ddot{φ} \\ \ddot{α} \\ \ddot{β}\end{matrix} ] = [ \begin{matrix}\dot{φ} \\ \dot{α} \\ \dot{β} \\ = {M}^{- 1} ( x ) C ( x ) - {M}^{- 1} ( x ) G ( x )\end{matrix} ] + [ \begin{matrix}{0}_{3 \times 2} \\ {M}^{- 1} ( x ) {S}^{T}\end{matrix} ] [ \begin{matrix}{τ}_{1} \\ {τ}_{2}\end{matrix} ] \qquad ( 30 )$$

$$f ( x ) = [ \begin{matrix}\dot{φ} \\ \dot{α} \\ \dot{β} \\ - {M}^{- 1} ( x ) C ( x ) - {M}^{- 1} ( x ) G ( x )\end{matrix} ] ,$$

where f(x) is the first control parameter.

$$g ( x ) = [ \begin{matrix}{0}_{3 \times 2} \\ {M}^{- 1} ( x ) {S}^{T}\end{matrix} ] ,$$

where g(x) is the second control parameter.

A safety objective is to enable a rotational velocity range of a wheel to fall between ±π/12 radian (rad)/s (in other words, a safety control parameter range of a safe rotational angular velocity is between ±π/12 rad/s), and enable a rotation angle φ of the wheel to fall between ±π/4 rad (in other words, a safety control parameter range of a safe rotation angle is between +/4 rad). To be specific, four CBFs in the following formula (31) to formula (34) may be designed.

$${h}_{1} ( x ) = - \dot{φ} + \frac{π}{12} \qquad ( 31 )$$

$${h}_{2} ( x ) = \dot{φ} + \frac{π}{12} \qquad ( 32 )$$

$${h}_{3} ( x ) = - φ + \frac{π}{4} \qquad ( 33 )$$

$${h}_{4} ( x ) = φ + \frac{π}{4} \qquad ( 34 )$$

First-order Lie derivatives of the CBFs are obtained based on the following formula (35) and formula (36). A first-order Lie derivative L_{f}h(x) is a first Lie derivative of a first control parameter f(x), and L_{g}h(x) is a second Lie derivative of a second control parameter g(x).

$${L}_{f} h ( x ) = \frac{\partial h ( x )}{x} f ( x ) = [ 0 , 0 , 0 , - 1 , 0 , 0 ] f ( x ) \qquad ( 35 )$$

$${L}_{g} h ( x ) = \frac{\partial h ( x )}{x} g ( x ) = [ 0 , 0 , 0 , - 1 , 0 , 0 ] g ( x ) \qquad ( 36 )$$

h(x) is a CBF, including h₁(x), h₂(x), h₃(x), and h₄(x).

For the CBF h₁(x), a constraint condition L_{f}h(x)+L_{g}h(x)u≥−α(h(x)) may be written as the following formula (37) and formula (38).

$${[ \begin{matrix}0 \\ 0 \\ 0 \\ 1 \\ 0 \\ 0\end{matrix} ]}^{T} f ( x ) + {[ \begin{matrix}0 \\ 0 \\ 0 \\ 1 \\ 0 \\ 0\end{matrix} ]}^{T} g ( x ) u \geq - 0.5 ( - \dot{φ} + \frac{π}{12} ) \qquad ( 37 )$$

$${( {M}^{- 1} C )}^{( 1 )} + {( {M}^{- 1} G )}^{( 1 )} - {( {M}^{- 1} {S}^{T} )}^{( 1 )} [ \begin{matrix}{τ}_{1} \\ {τ}_{2}\end{matrix} ] \geq - 0.5 ( - \dot{φ} + \frac{π}{12} ) \qquad ( 38 )$$

For the CBF h₂(x), the constraint condition L_{f}h(x)+L_{g}h(x)u≥−α(h(x)) may be written as the following formula (39) and formula (40).

$${[ \begin{matrix}0 \\ 0 \\ 0 \\ 1 \\ 0 \\ 0\end{matrix} ]}^{T} f ( x ) + {[ \begin{matrix}0 \\ 0 \\ 0 \\ 1 \\ 0 \\ 0\end{matrix} ]}^{T} g ( x ) u \geq - 0.5 ( \dot{φ} + \frac{π}{12} ) \qquad ( 39 )$$

$${( - {M}^{- 1} C )}^{( 1 )} - {( {M}^{- 1} G )}^{( 1 )} + {( {M}^{- 1} {S}^{T} )}^{( 1 )} [ \begin{matrix}{τ}_{1} \\ {τ}_{2}\end{matrix} ] \geq - 0.5 ( \dot{φ} + \frac{π}{12} ) \qquad ( 40 )$$

For the CBF h₃(x), first-order Lie derivatives are shown in the following formula (41) to formula (45).

$${L}_{f} {h}_{3} ( x ) = \frac{\partial {h}_{3} ( x )}{x} f ( x ) = [ - 1 , 0 , 0 , 0 , 0 , 0 ] f ( x ) = - {f ( x )}^{( 1 )} = - \dot{φ} \qquad ( 41 )$$

$$\begin{matrix}{L}_{f}^{2} {h}_{3} ( x ) = {L}_{f} ( - \dot{φ} ) \\ = - {L}_{f} \dot{φ} \\ = - [ 0 , 0 , 0 , 1 , 0 , 0 ] f ( x ) \\ = - {f ( x )}^{( 4 )} \\ = {( {M}^{- 1} C )}^{( 1 )} + {( {M}^{- 1} G )}^{( 1 )}\end{matrix} \qquad ( 42 )$$

$$\begin{matrix}{L}_{g} {L}_{f} {h}_{3} ( x ) = {L}_{g} ( - \dot{φ} ) \\ = - {L}_{g} \dot{φ} \\ = - [ 0 , 0 , 0 , 1 , 0 , 0 ] g ( x ) \\ = - {( {M}^{- 1} {S}^{T} )}^{( 1 )}\end{matrix} \qquad ( 43 )$$

$${η}_{b} = [ \begin{matrix}- φ + \frac{π}{4} \\ - \dot{φ}\end{matrix} ] \qquad ( 44 )$$

$${K}_{α} ( x ) = [ \begin{matrix}{K}_{α1} & {K}_{α2}\end{matrix} ] \qquad ( 45 )$$

A constraint condition

$${L}_{f}^{2} h ( x ) + {L}_{g} {L}_{f} h ( x ) u ( x ) \geq - {K}_{α} {η}_{b}$$

may be written as the following formula (46).

$${( {M}^{- 1} C )}^{( 1 )} + {( {M}^{- 1} G )}^{( 1 )} - {( {M}^{- 1} {S}^{T} )}^{( 1 )} [ \begin{matrix}{τ}_{1} \\ {τ}_{2}\end{matrix} ] \geq - {K}_{α} {η}_{b} = - {K}_{α1} ( - φ + \frac{π}{4} ) - {K}_{α2} ( - \dot{φ} ) \qquad ( 46 )$$

For the CBF h₄(x), the constraint condition

$${L}_{f}^{2} h ( x ) + {L}_{g} {L}_{f} h ( x ) u ( x ) \geq - {K}_{α} {η}_{b}$$

may be written as the following formula (47).

$$- {( {M}^{- 1} C )}^{( 1 )} - {( {M}^{- 1} G )}^{( 1 )} + {( {M}^{- 1} {S}^{T} )}^{( 1 )} [ \begin{matrix}{τ}_{1} \\ {τ}_{2}\end{matrix} ] \geq - {K}_{α} {η}_{b} = - {K}_{α1} ( φ + \frac{π}{4} ) - {K}_{α2} \dot{φ} \qquad ( 47 )$$

In this way, the formulas (38), (40), (46), and (47) may be used as four new constraint conditions added during WBC solving, and a torque of each joint is correspondingly obtained through solving, to control the robot.

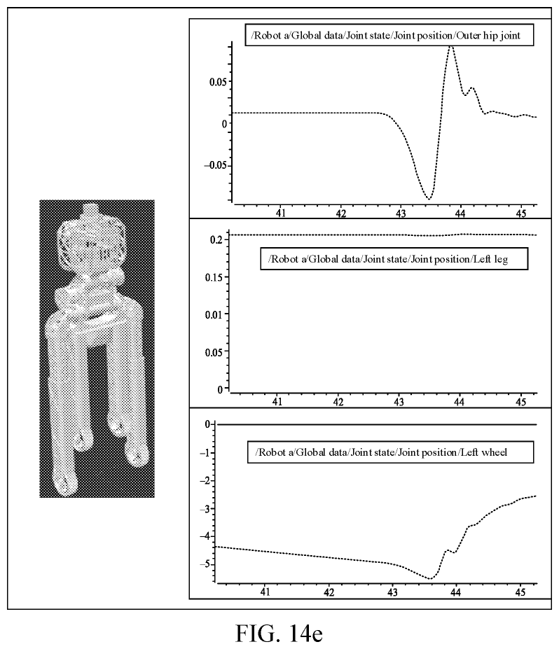

The following testifies effectiveness of applying the CBF to a WBC framework in a scenario of two-wheel balancing on a flat ground. FIG. 14a to FIG. 14f show effect of robot simulation to which the foregoing control algorithm is applied. Diagrams of simulation of a robot a are shown on the left of FIG. 14a to FIG. 14f. Line graphs on the right of FIG. 14a to FIG. 14f show control parameter change curves of different joints of the robot. In the control parameter change curve, a vertical coordinate represents a corresponding control parameter (measured in a unit of the corresponding control parameter, for example, an angle of an outer hip joint is measured in rad, a length of a left-leg joint is measured in meters, and a rotation angle of a wheel-hub motor of a left wheel, namely, the rotation angle φ of the wheel, is measured in rad), and a horizontal coordinate represents time, which is measured in minutes. It can be learned that, in the simulation diagrams, when the rotation angle of the wheel-hub motor approaches a specified angle, the wheel bounces back. The rotation angle of the wheel-hub motor of the robot can be kept around the specified angle through parameter configuration. In FIG. 14a to FIG. 14f, simulation diagrams corresponding to the angle of the outer hip joint, the length of the left-leg joint, and the rotation angle of the wheel-hub motor of the left wheel are shown from top to bottom. FIG. 14b and FIG. 14d show merely data detection. It can be learned from the rotation angle of the wheel-hub motor of the left wheel in FIG. 14f that, when the rotation angle approaches 5 rad (to be specific, −5 rad shown in FIG. 14f indicates that an angle by which a wheel rotates in an opposite direction approaches 5 rad), the wheel bounces back. A rotation angle of a wheel of the robot can be kept around +5 rad and −5 rad through parameter configuration.

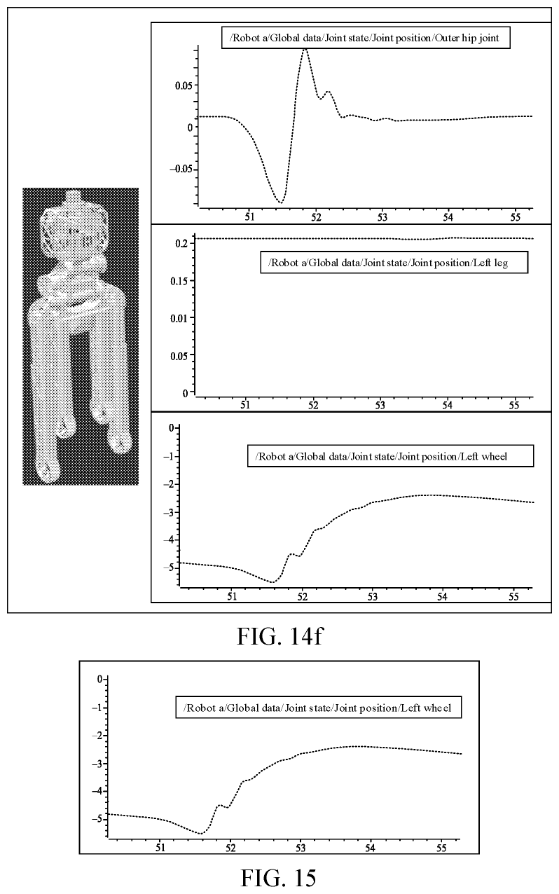

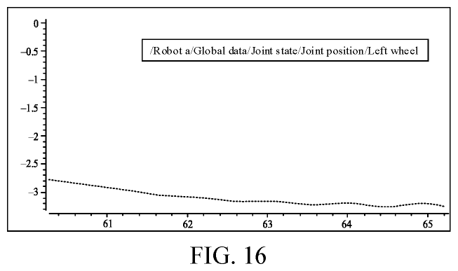

For ease of observation, data of the rotation angle of the wheel-hub motor of the left wheel in FIG. 14f within a full period of time is separately shown in FIG. 15. Five rad (5 rad) herein is equivalent to the π/4 rad given in the foregoing formula-based derivation, and may be flexibly set to a corresponding value according to a requirement. For example, when a lower limit of a safety constraint is changed to −π rad, data of the rotation angle of the wheel-hub motor of the left wheel within a full period of time is shown in FIG. 16. Motion control of the robot has similar effect, and only upper and lower limits of the rotation angle of the wheel-hub motor of the left wheel are different, where the upper and lower limits are around ±π rad.

It can be learned that, in the foregoing value examples, the wheel of the robot bounces back only after the wheel exceeds the specified safety value range: 5 rad. Actually, in an experiment, whether control overshoot occurs in a range of a safety constraint and whether a wheel bounces back or stays in place after being blocked are related to controller parameters. This may be correspondingly adjusted as needed based on an experimental phenomenon during actual application.

In the embodiments of the present disclosure, content of user information is involved, for example, a current state parameter, a basic control parameter, a safety control parameter, and a motion control parameter of a to-be-controlled robot. If data related to user information or enterprise information is involved, when the embodiments of the present disclosure are applied to specific products or technologies, user permission or consent needs to be obtained, or fuzzy processing is performed on the information to eliminate a correspondence between the information and a user. In addition, during related data collection and processing in the embodiments of the present disclosure in an exemplary application, informed consent or individual consent of a personal information subject needs to be obtained in strict accordance with requirements of related laws and regulations, and subsequent data use and processing are performed within an authorized scope of laws and regulations and the personal information subject.

The following continues to describe an exemplary structure in which the robot control apparatus 455 provided in the embodiments of the present disclosure is implemented as software modules. In some embodiments, as shown in FIG. 2, software modules of the robot control apparatus 455 stored in the memory 450 may include: an obtaining module 4551, configured to obtain a current state parameter of a to-be-controlled robot at a current moment; a basic control parameter determining module 4552, configured to invoke a state regulator to determine a basic control parameter of each joint of the to-be-controlled robot based on a preset dynamics model and the current state parameter; a parameter filtering module 4553, configured to perform parameter filtering on the basic control parameter to obtain a safety control parameter of each joint of the to-be-controlled robot; a motion control parameter determining module 4554, configured to determine a motion control parameter of each joint of the to-be-controlled robot based on the safety control parameter of each joint; and a control module 4555, configured to control each joint of the to-be-controlled robot at the current moment based on the motion control parameter of each joint.

In some embodiments, the parameter filtering module 4553 is further configured to: construct a CBF based on a preset control input parameter and the basic control parameter, the CBF including a safety objective function and a constraint condition; and determine, based on the constraint condition, a safety control parameter of each joint of the to-be-controlled robot when the safety objective function obtains a minimum value.

In some embodiments, the motion control parameter determining module 4554 is further configured to: determine an expected acceleration of each joint of the to-be-controlled robot based on the safety control parameter of each joint and the current state parameter; and invoke a whole-body dynamics model of the to-be-controlled robot to determine the motion control parameter of each joint of the to-be-controlled robot based on the expected acceleration of each joint.

In some embodiments, the current state parameter includes an actual state variable, and the expected acceleration includes an expected COM acceleration. The motion control parameter determining module 4554 is further configured to: invoke a state observer to determine the following parameters based on the safety control parameter of each joint and the current state parameter: a reference COM position and a reference COM velocity of the to-be-controlled robot, a reference distance between the reference COM position and a current virtual contact point, and a reference velocity corresponding to the reference distance; determine a reference state variable based on the reference distance, the reference velocity, the reference COM position, and the reference COM velocity; invoke a state regulator to determine a state feedback parameter of a pre-constructed inverted pendulum model; and determine an expected COM acceleration of each joint based on the state feedback parameter of the inverted pendulum model, the reference state variable, and the actual state variable.

In some embodiments, the motion control parameter determining module 4554 is further configured to: invoke the whole-body dynamics model of the to-be-controlled robot and the state regulator to construct an objective function based on the expected acceleration of each joint; obtain a preset parameter constraint condition for each joint of the to-be-controlled robot; determine a minimum value of the objective function of each joint based on the parameter constraint condition; and determine the motion control parameter of each joint of the to-be-controlled robot based on the minimum value.

In some embodiments, the apparatus 455 further includes a safety control module, and the safety control module is configured to: construct a safety constraint condition for the to-be-controlled robot; invoke the whole-body dynamics model of the to-be-controlled robot to determine a first motion control parameter of each joint of the to-be-controlled robot based on the safety control parameter of each joint and the safety constraint condition; and for each joint of the to-be-controlled robot, control the joint at the current moment based on a first motion control parameter of the joint.

In some embodiments, the safety control parameter of each joint includes a safe rotation angle and a safe rotational angular velocity; and the safety control module is further configured to: determine a safety control parameter range of the safe rotation angle and a safety control parameter range of the safe rotational angular velocity; construct a CBF based on the safety control parameter range of the safe rotation angle and the safety control parameter range of the safe rotational angular velocity; and invoke the preset dynamics model to determine the safety constraint condition for the to-be-controlled robot based on the CBF.

In some embodiments, the safety control module is further configured to: convert the preset dynamics model into a first dynamics model; determine a first control parameter and a second control parameter based on the first dynamics model and the current state parameter; determine a first Lie derivative of the first control parameter and a second Lie derivative of the second control parameter based on the first control parameter, the second control parameter, and the CBF; and determine the safety constraint condition based on the first Lie derivative, the second Lie derivative, and the CBF.

In some embodiments, the safety control module is further configured to: determine the first Lie derivative of the first control parameter based on the first control parameter and the CBF; and determine the second Lie derivative of the second control parameter based on the second control parameter and the CBF.

In some embodiments, the basic control parameter determining module 4552 is further configured to: convert the preset dynamics model into a state space model; invoke a state regulator to determine a state feedback parameter of the to-be-controlled robot based on the state space model; and determine the basic control parameter of each joint of the to-be-controlled robot based on the state feedback parameter of the to-be-controlled robot and the current state parameter.

In some embodiments, the basic control parameter determining module 4552 is further configured to: for each joint of the to-be-controlled robot, obtain a state variable of the joint in the current state parameter; and determine a product of the state feedback parameter and the state variable as a basic control parameter of the joint.

The descriptions of the apparatus in this embodiment of the present disclosure are similar to the descriptions of the foregoing method embodiments, and the apparatus has beneficial effects similar to those of the method embodiments. Therefore, details are not described again. For technical details not disclosed in this apparatus embodiment, refer to the descriptions of the method embodiments of the present disclosure for understanding.

The embodiments of the present disclosure provide a computer-readable storage medium, having computer-executable instructions stored therein. When the computer-executable instructions are executed by a processor, the processor is enabled to perform the robot control method provided in the embodiments of the present disclosure, for example, the robot control method shown in FIG. 3.

The embodiments of the present disclosure provide a computer program product. The computer program product includes computer-executable instructions. The computer-executable instructions are stored in a computer-readable storage medium. A processor of an electronic device reads the computer-executable instructions from the computer-readable storage medium, and the processor executes the computer-executable instructions, to enable the electronic device to perform the robot control method in the embodiments of the present disclosure.

In some embodiments, the computer-readable storage medium may be a memory such as a RAM, a ROM, a flash memory, a magnetic surface memory, an optical disc, or a compact disc read-only memory (CD-ROM), or may be various devices including one or any combination of the foregoing memories.

In some embodiments, the computer-executable instructions may be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may, but not necessarily, correspond to a file in a file system, and may be stored as a part of a file that stores other programs or data, for example, stored in one or more scripts of a Hypertext Markup Language (HTML) document, stored in a single file dedicated to the discussed program, or stored in a plurality of co-files (for example, files that store one or more modules, subroutines, or code parts).

In an example, the computer-executable instructions may be deployed on one electronic device for execution, or may be executed on a plurality of electronic devices at one location, or may be executed on a plurality of electronic devices that are distributed at a plurality of locations and that are interconnected through a communication network.

The foregoing descriptions are merely embodiments of the present disclosure and are not intended to limit the protection scope of the present disclosure. Any modification, equivalent replacement, or improvement made without departing from the spirit and scope of the present disclosure fall within the protection scope of the present disclosure.

What is claimed is:

1. A robot control method, performed by an electronic device, the method comprising:
obtaining a current state parameter of a to-be-controlled robot at a current moment;
determining a basic control parameter of each joint of the to-be-controlled robot based on a preset dynamics model and the current state parameter;
performing parameter filtering on the basic control parameter to obtain a safety control parameter of each joint of the to-be-controlled robot;
determining a motion control parameter of each joint of the to-be-controlled robot based on the safety control parameter of each joint; and
controlling each joint of the to-be-controlled robot at the current moment based on the motion control parameter of each joint.

2. The method according to claim 1, wherein the performing parameter filtering on the basic control parameter to obtain a safety control parameter of each joint of the to-be-controlled robot comprises:
constructing a control barrier function (CBF) based on a preset control input parameter and the basic control parameter, the CBF comprising a safety objective function and a constraint condition; and
determining, based on the constraint condition, a safety control parameter of each joint of the to-be-controlled robot when the safety objective function obtains a minimum value.

3. The method according to claim 1, wherein the determining a motion control parameter of each joint of the to-be-controlled robot based on the safety control parameter of each joint comprises:
determining an expected acceleration of each joint of the to-be-controlled robot based on the safety control parameter of each joint and the current state parameter; and
invoking a whole-body dynamics model of the to-be-controlled robot to determine the motion control parameter of each joint of the to-be-controlled robot based on the expected acceleration of each joint.

4. The method according to claim 3, wherein the current state parameter comprises an actual state variable, and the expected acceleration comprises an expected center of mass (COM) acceleration; and
the determining an expected acceleration of each joint of the to-be-controlled robot based on the safety control parameter of each joint and the current state parameter comprises:
invoking a state observer to determine the following parameters based on the safety control parameter of each joint and the current state parameter: a reference COM position and a reference COM velocity of the to-be-controlled robot, a reference distance between the reference COM position and a current virtual contact point, and a reference velocity corresponding to the reference distance;
determining a reference state variable based on the reference distance, the reference velocity, the reference COM position, and the reference COM velocity;
invoking a state regulator to determine a state feedback parameter of a pre-constructed inverted pendulum model; and
determining an expected COM acceleration of each joint based on the state feedback parameter of the inverted pendulum model, the reference state variable, and the actual state variable.

5. The method according to claim 3, wherein the invoking a whole-body dynamics model of the to-be-controlled robot to determine the motion control parameter of each joint of the to-be-controlled robot based on the expected acceleration of each joint comprises:
invoking the whole-body dynamics model of the to-be-controlled robot and the state regulator to construct an objective function based on the expected acceleration of each joint;
obtaining a preset parameter constraint condition for each joint of the to-be-controlled robot;
determining a minimum value of the objective function of each joint based on the parameter constraint condition; and
determining the motion control parameter of each joint of the to-be-controlled robot based on the minimum value.

6. The method according to claim 1, wherein the method further comprises:
constructing a safety constraint condition for the to-be-controlled robot;
invoking the whole-body dynamics model of the to-be-controlled robot to determine a first motion control parameter of each joint of the to-be-controlled robot based on the safety control parameter of each joint and the safety constraint condition; and
for each joint of the to-be-controlled robot, controlling the joint at the current moment based on a first motion control parameter of the joint.

7. The method according to claim 6, wherein the safety control parameter of each joint comprises a safe rotation angle and a safe rotational angular velocity, and the constructing a safety constraint condition for the to-be-controlled robot comprises:
determining a safety control parameter range of the safe rotation angle and a safety control parameter range of the safe rotational angular velocity;
constructing a CBF based on the safety control parameter range of the safe rotation angle and the safety control parameter range of the safe rotational angular velocity; and
invoking the preset dynamics model to determine the safety constraint condition for the to-be-controlled robot based on the CBF.

8. The method according to claim 7, wherein the invoking the preset dynamics model to determine the safety constraint condition for the to-be-controlled robot based on the CBF comprises:
converting the preset dynamics model into a first dynamics model;
determining a first control parameter and a second control parameter based on the first dynamics model and the current state parameter;
determining a first Lie derivative of the first control parameter and a second Lie derivative of the second control parameter based on the first control parameter, the second control parameter, and the CBF; and
determining the safety constraint condition based on the first Lie derivative, the second Lie derivative, and the CBF.

9. The method according to claim 8, wherein the determining a first Lie derivative of the first control parameter and a second Lie derivative of the second control parameter based on the first control parameter, the second control parameter, and the CBF comprises:
determining the first Lie derivative of the first control parameter based on the first control parameter and the CBF; and
determining the second Lie derivative of the second control parameter based on the second control parameter and the CBF.

10. The method according to claim 1, wherein the determining a basic control parameter of each joint of the to-be-controlled robot based on a preset dynamics model and the current state parameter comprises:
converting the preset dynamics model into a state space model;
invoking a state regulator to determine a state feedback parameter of the to-be-controlled robot based on the state space model; and
determining the basic control parameter of each joint of the to-be-controlled robot based on the state feedback parameter of the to-be-controlled robot and the current state parameter.

11. The method according to claim 10, wherein the determining the basic control parameter of each joint of the to-be-controlled robot based on the state feedback parameter of the to-be-controlled robot and the current state parameter comprises:
for each joint of the to-be-controlled robot, obtaining a state variable of the joint in the current state parameter; and
determining a product of the state feedback parameter and the state variable as the basic control parameter of the joint.

12. A robot control apparatus, comprising:
at least one memory configured to store program code; and
at least one processor configured to read the program code and operate as instructed by the program code, the program code comprising:
an obtaining code configured to cause the at least one of the at least one processor to obtain a current state parameter of a to-be-controlled robot at a current moment;
a basic control parameter determining code configured to cause the at least one of the at least one processor to invoke a state regulator to determine a basic control parameter of each joint of the to-be-controlled robot based on a preset dynamics model and the current state parameter;
a parameter filtering code configured to cause the at least one of the at least one processor to perform parameter filtering on the basic control parameter to obtain a safety control parameter of each joint of the to-be-controlled robot;
a motion control parameter determining code configured to cause the at least one of the at least one processor to determine a motion control parameter of each joint of the to-be-controlled robot based on the safety control parameter of each joint; and
a control code configured to cause the at least one of the at least one processor to control each joint of the to-be-controlled robot at the current moment based on the motion control parameter of each joint.

13. The robot control apparatus according to claim 12, wherein the parameter filtering code comprising:
a constructing code configured to cause the at least one of the at least one processor to construct a control barrier function (CBF) based on a preset control input parameter and the basic control parameter, the CBF comprising a safety objective function and a constraint condition; and
a first determining code configured to cause the at least one of the at least one processor to determine, based on the constraint condition, a safety control parameter of each joint of the to-be-controlled robot when the safety objective function obtains a minimum value.

14. The robot control apparatus according to claim 12, wherein the motion control parameter determining code comprising:
a second determining code configured to cause the at least one of the at least one processor to determine an expected acceleration of each joint of the to-be-controlled robot based on the safety control parameter of each joint and the current state parameter; and
a first invoking code configured to cause the at least one of the at least one processor to invoke a whole-body dynamics model of the to-be-controlled robot to determine the motion control parameter of each joint of the to-be-controlled robot based on the expected acceleration of each joint.

15. The robot control apparatus according to claim 14, wherein the current state parameter comprises an actual state variable, and the expected acceleration comprises an expected center of mass (COM) acceleration; and the second determining code comprising:
a second invoking code configured to cause the at least one of the at least one processor to invoke a state observer to determine the following parameters based on the safety control parameter of each joint and the current state parameter: a reference COM position and a reference COM velocity of the to-be-controlled robot, a reference distance between the reference COM position and a current virtual contact point, and a reference velocity corresponding to the reference distance;
a third determining code configured to cause the at least one of the at least one processor to determine a reference state variable based on the reference distance, the reference velocity, the reference COM position, and the reference COM velocity;
a third invoking code configured to cause the at least one of the at least one processor to invoke a state regulator to determine a state feedback parameter of a pre-constructed inverted pendulum model; and
a fourth determining code configured to cause the at least one of the at least one processor to determine an expected COM acceleration of each joint based on the state feedback parameter of the inverted pendulum model, the reference state variable, and the actual state variable.

16. The robot control apparatus according to claim 14, wherein the first invoking code further comprising:
a fourth invoking code configured to cause the at least one of the at least one processor to invoke the whole-body dynamics model of the to-be-controlled robot and the state regulator to construct an objective function based on the expected acceleration of each joint;
an obtaining code configured to cause the at least one of the at least one processor to obtain a preset parameter constraint condition for each joint of the to-be-controlled robot;
a fifth determining code configured to cause the at least one of the at least one processor to determine a minimum value of the objective function of each joint based on the parameter constraint condition; and
a sixth determining code configured to cause the at least one of the at least one processor to determine the motion control parameter of each joint of the to-be-controlled robot based on the minimum value.

17. The robot control apparatus according to claim 12, wherein the program code further comprising:
a first constructing code configured to cause the at least one of the at least one processor to construct a safety constraint condition for the to-be-controlled robot;
a fifth invoking code configured to cause the at least one of the at least one processor to invoke the whole-body dynamics model of the to-be-controlled robot to determine a first motion control parameter of each joint of the to-be-controlled robot based on the safety control parameter of each joint and the safety constraint condition; and
a controlling code configured to cause the at least one of the at least one processor to, for each joint of the to-be-controlled robot, control the joint at the current moment based on a first motion control parameter of the joint.

18. The robot control apparatus according to claim 17, wherein the safety control parameter of each joint comprises a safe rotation angle and a safe rotational angular velocity, and
the first constructing code comprising:
a seventh determining code configured to cause the at least one of the at least one processor to determine a safety control parameter range of the safe rotation angle and a safety control parameter range of the safe rotational angular velocity;
a second constructing code configured to cause the at least one of the at least one processor to construct a CBF based on the safety control parameter range of the safe rotation angle and the safety control parameter range of the safe rotational angular velocity; and
a sixth invoking code configured to cause the at least one of the at least one processor to invoke the preset dynamics model to determine the safety constraint condition for the to-be-controlled robot based on the CBF.

19. The robot control apparatus according to claim 17, wherein the sixth invoking code comprising:
a converting code configured to cause the at least one of the at least one processor to convert the preset dynamics model into a first dynamics model;
an eighth determining code configured to cause the at least one of the at least one processor to determine a first control parameter and a second control parameter based on the first dynamics model and the current state parameter;
a ninth determining code configured to cause the at least one of the at least one processor to determine a first Lie derivative of the first control parameter and a second Lie derivative of the second control parameter based on the first control parameter, the second control parameter, and the CBF; and
a tenth determining code configured to cause the at least one of the at least one processor to determine the safety constraint condition based on the first Lie derivative, the second Lie derivative, and the CBF.

20. A non-transitory computer-readable storage medium, storing computer code, the computer code which, when executed by at least one processor, causes the at least one processor to at least:
obtain a current state parameter of a to-be-controlled robot at a current moment;
determine a basic control parameter of each joint of the to-be-controlled robot based on a preset dynamics model and the current state parameter;
perform parameter filtering on the basic control parameter to obtain a safety control parameter of each joint of the to-be-controlled robot;
determine a motion control parameter of each joint of the to-be-controlled robot based on the safety control parameter of each joint; and
control each joint of the to-be-controlled robot at the current moment based on the motion control parameter of each joint.
